(19) United States
(12) Patent Application Publication
(10) Pub. No.: US 2018/0108974 A1
(43) Pub. Date: Apr. 19, 2018

(54) SYSTEM AND METHOD FOR TRACKING THE STATUS OF PARCELS AND MAILED MARKETING MEDIA AND REPORTING THE DISPOSITION THEREOF

(71) Applicant: NanoThings, Inc., New York, NY (US)

(72) Inventors: Timothy Williams, New York, NY (US); Gary Lomp, Centerport, NY (US); Friedrich Eibensteiner, Linz (AT); Josep Miquel Jornet, Clarence Center, NY (US)

(21) Appl. No.: 15/783,623

(22) Filed: Oct. 13, 2017

Related U.S. Application Data
(63) Continuation-in-part of application No. 15/703,311, filed on Sep. 13, 2017.
(60) Provisional application No. 62/408,551, filed on Oct. 14, 2016.

(51) Int. Cl. H01Q 1/22; G08C 17/02; H04W 4/02; H01Q 1/27; H04W 4/00

(52) U.S. Cl. CPC H01Q 1/2225; G08C 17/02; H04W 4/008; H01Q 1/27; H04W 4/02

(57) ABSTRACT

An apparatus includes a printed antenna, a printed battery, a transmitter powered by the printed battery, and control circuitry configured to control the transmitter to transmit, using the printed antenna, information detected by a sensor.

### RELATED APPLICATIONS

This application claims the benefit under 35 U.S.C. § 119(e) to U.S. Provisional Application Ser. No. 62/408,551, titled “A SYSTEM AND METHOD FOR TRACKING THE STATUS OF PARCELS AND MAILED MARKETING MEDIA AND REPORTING THE DISPOSITION THEREOF” filed on Oct. 14, 2016, which is herein incorporated by reference in its entirety. This application is also a continuation-in-part of and claims priority under 35 U.S.C. § 120 to U.S. application Ser. No. 15/703,311, titled “PRINTED TRACKING DEVICE, AND SYSTEM AND METHOD FOR USE IN A LOW POWER WIDE AREA NETWORK” filed on Sep. 13, 2017, which itself claims the benefit under 35 U.S.C. § 119(e) to U.S. Provisional Application Ser. No. 62/408,551, titled “A SYSTEM AND METHOD FOR TRACKING THE STATUS OF PARCELS AND MAILED MARKETING MEDIA AND REPORTING THE DISPOSITION THEREOF” filed on Oct. 14, 2016, the contents of U.S. application Ser. No. 15/703,311 is also herein incorporated by reference in its entirety.

### FIELD

Disclosed embodiments relate to a tracking and feedback system.

### BACKGROUND

Tracking systems may be used to track items as they move from one location to another.

### SUMMARY

In one aspect, an apparatus is provided. The apparatus includes a printed antenna, a printed battery, a transmitter powered by the printed battery, and control circuitry configured to control the transmitter to transmit, using the printed antenna, information detected by a sensor.

In another aspect, a tracking device for use in a low power wide area network (LPWAN) includes a circuit on a substrate. The circuit includes a processor, a memory, a transmitter, and a power coupler configured to receive power from an external source. A printed antenna is on the substrate and is communicatively coupled to the circuit. A sensor is communicatively coupled to the circuit.

In one embodiment, the tracking device includes a receiver. In one embodiment, the substrate is at least one of a thin film, a cardboard member, a plastic member, a paper member, a composite wood member, and a circuit board. In one embodiment, the circuit and the antenna are coplanar. In one embodiment, the processor is a small state machine or a micro-coded bit slice processor. In one embodiment, the tracking device further includes a clock. In one embodiment, the sensor is configured to monitor at least one data metric the data metric comprising one of more of: a temperature, a measurement of relative humidity, a traveling velocity, an acceleration, a measure of light, a shock, a pressure, a vibration, a location, a gas, a fire, an orientation in space, a g-force, a sound, a stacking height, a weight, or a state of integrity. In one embodiment, the processor is configured to create an event code based on input received from the sensor. In one embodiment, the transmitter is configured to transmit an event code. In one embodiment, the tracking device includes a power source. In one embodiment, the power source is one or more of a battery, a capacitor, a super capacitor, a solar power collector, or a wireless power device. In one embodiment, the power source is a printed battery or a printed capacitor. In one embodiment, the LPWAN network is a SIGFOX network, a long range radio “LoRa” network, a Weightless network, a Greenwaves network, an LTE-MTC network, a Haystack network, an Ingenu Random Phase Multiple Access, or a Narrow-Band Internet of Things (“N-B IoT”) network.

In another aspect, a tracking device for use in a low power wide area network (LPWAN) includes a circuit on a substrate. The circuit further includes a finite state machine, a transmitter, and a power coupler configured to receive power from an external source, a printed antenna on the substrate communicatively coupled to the circuit, and a sensor communicatively coupled to the circuit.

In another aspect, system for tracking a data metric of an item includes a tracking device for use in a low power wide area network (LPWAN) that includes a circuit on a substrate. The circuit includes a processor, a memory, a transmitter, and a power coupler configured to receive power from an external source. A printed antenna is on the substrate and is communicatively coupled to the circuit. A sensor is communicatively coupled to the circuit. A low power wide area network configured to receive and transmit the data metric is also provided. A computer processor is configured to receive and analyze the data metric.

In another aspect, a method of tracking an item is provided. The method includes, a tracking device for use in a low power wide area network (LPWAN) includes a circuit on a substrate. The circuit includes a processor, a memory, a transmitter, and a power coupler configured to receive power from an external source. A printed antenna is on the substrate and is communicatively coupled to the circuit. A sensor is communicatively coupled to the circuit. The method includes receiving from the tracking device a data metric measured by the sensor; and analyzing the data metric in order to determine a tracking state.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows an overall block diagram of the system;

FIGS. 2, 2a, 2b and 2c show diagrams of the intelligent transponder to be embedded in the parcel;

FIGS. 3 and 3a show an exemplary printed antenna and sensor circuit arrangement;

FIG. 4 is a flow chart according to one embodiment;

FIG. 5 is a block diagram of a tracking device according to one embodiment;

FIG. 6 is a diagram of a tracking system according to one embodiment;

FIGS. 7A-7C show exemplary sensor circuitry;

FIG. 8 shows exemplary sensor circuitry;

FIG. 9 shows an exemplary sensor register;

FIG. 10 shows an exemplary sensor logic signal generator;

FIG. 11 shows an exemplary feedback message and format;

FIG. 12 shows a process that provides conductivity to each page of a magazine;

FIG. 13 shows a sensor design to measure opening (of a magazine page, for example);

FIG. 14 shows an interactive sensor design (in a magazine ad, for example);

FIG. 15 shows a buttonless push-sensor (in a magazine ad, for example);

FIG. 16 shows a process that gives conductivity to each page or multiple pages (of a magazine, for example);

FIG. 17 shows an example of a recall letter opening verification;

FIG. 18 shows an example of a medical recall application (tracking, verification); and

FIG. 19 shows a belly band incorporating an embodiment of the technology.

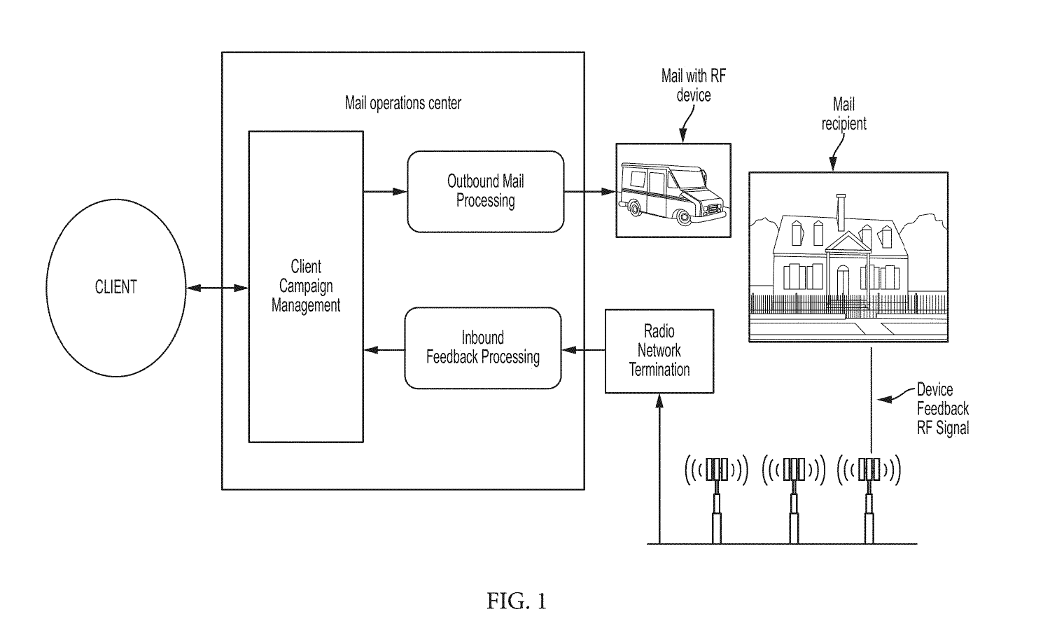

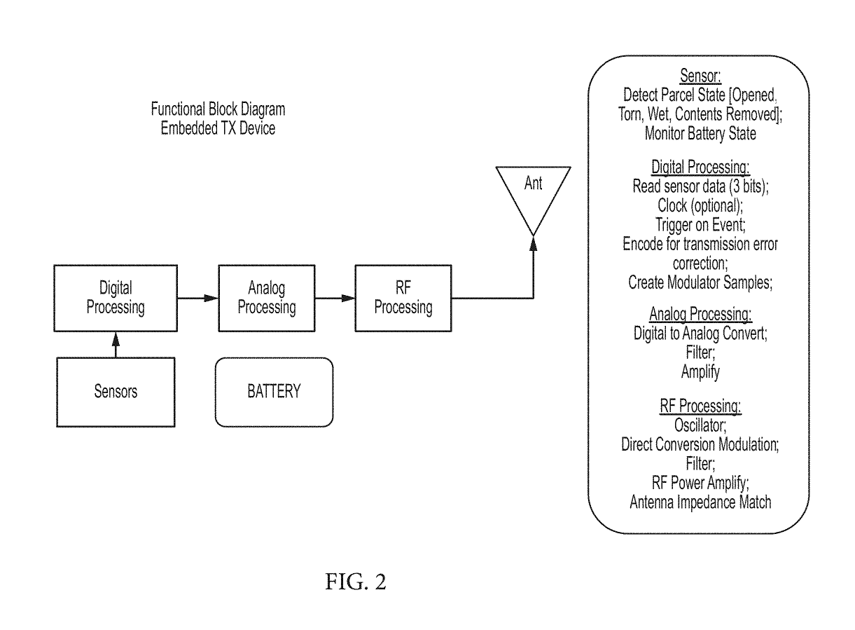

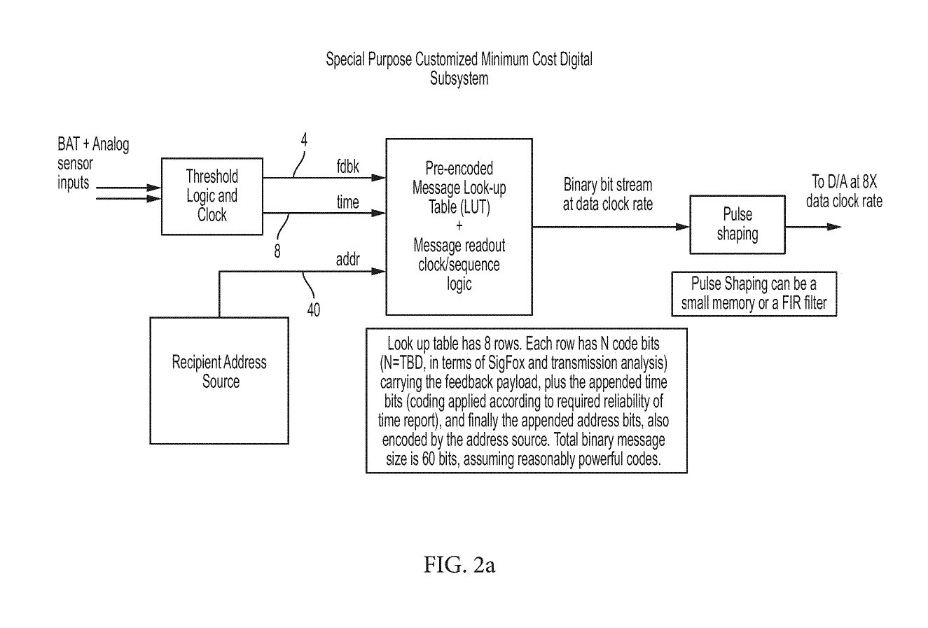

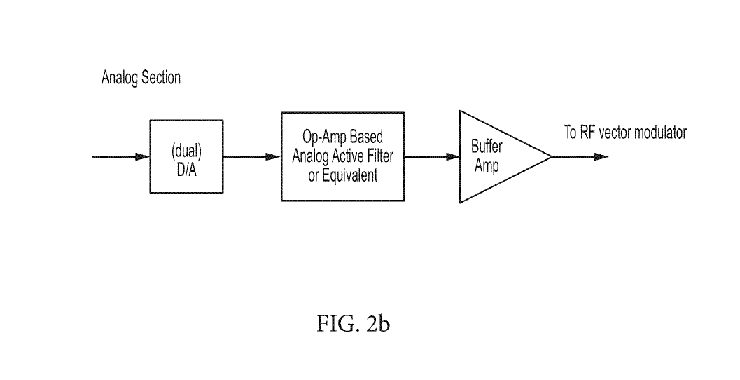

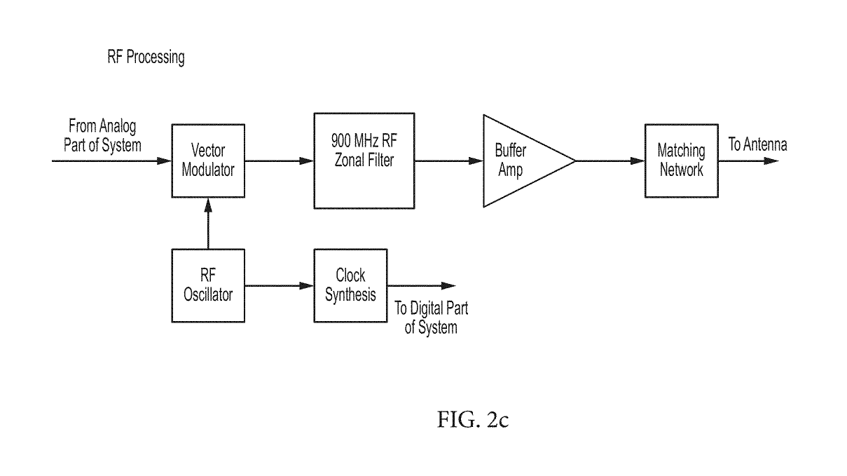

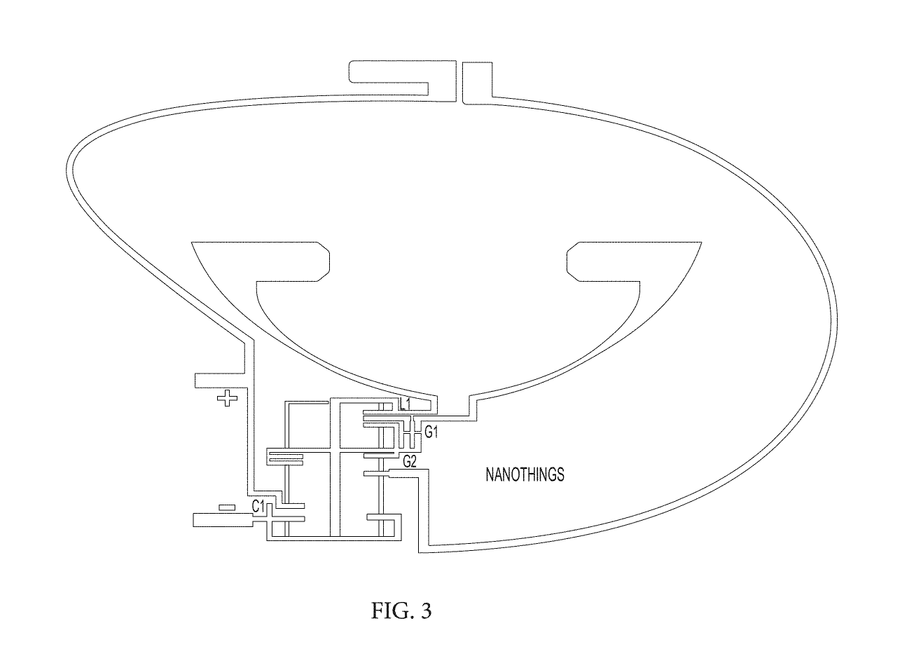

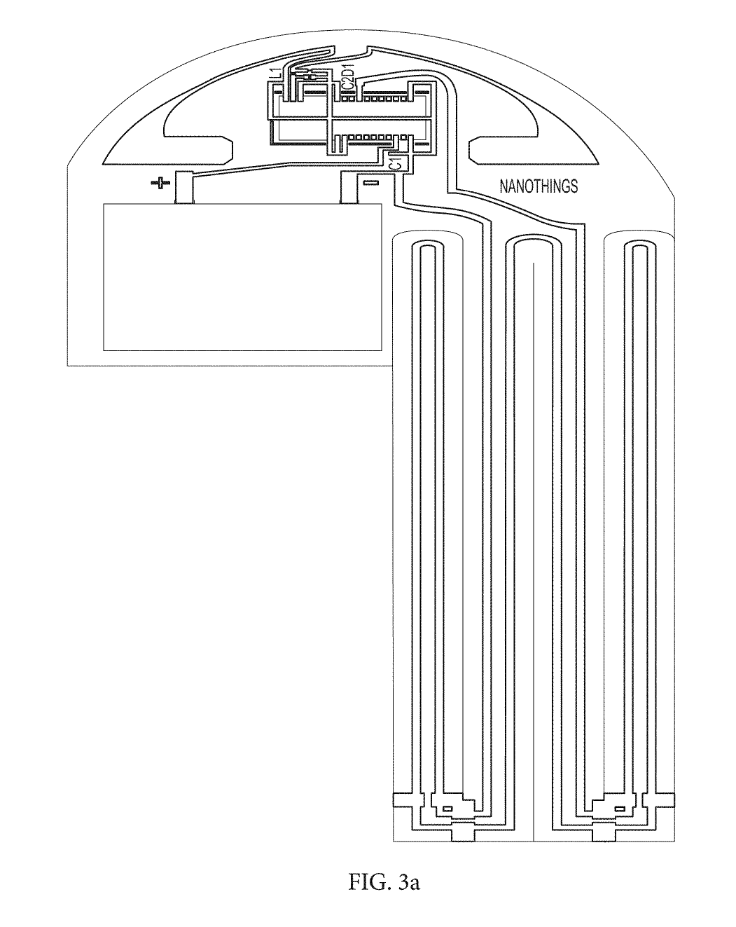

### DETAILED DESCRIPTION

In the United States the Media Mail-based marketing and advertising business is a (USD) 46 billion dollar industry. The size of the global industry is at least 10 times that figure. For over a century this industry has operated in a manner that provides only the most primitive feedback relating to the effectiveness of a given mass mailing campaign, namely, whether or not the person converted (the definition by which varies from advertiser to advertiser), and only in such events, the mailing campaign operator (or other surrogate agent) will receive positive notification of said recipient's interest in and response to the material. However, In the vast majority of cases, the media or parcel is discarded unopened, opened and then discarded, destroyed by the recipient (e.g., shredded) or allowed to remain in any one of a number of states of oblivion.

In profound contrast, in the electronic commerce and digital marketing/advertising paradigm, which is enabled by the Internet and by the concomitant profusion of personal digital electronic technology such as smart phones and wireless computer tablets, operators of digital and electronic advertising and marketing campaigns are afforded the powerful benefit of specific feedback from the recipient in the form of tracking, logging, parsing and reporting recipient's actions through the use of “cookies”, pixel tracking, and various other means. These actions include “clicking” on content, reading content, saving content, and other information that can be subjected to data analytics that reveals recipient's reaction, interest, intent and susceptibility to the marketing proffer. It is estimated that the use of these feedback techniques increases the effectiveness and efficiency (cost/acquisition of a customer) of the marketing or advertising campaign by 300 to 500 percent.

In view of the inherently blind, open-loop (no or limited feedback) nature of the conventional non-electronic mode of marketing, and in view of the immensely more effective and more efficient electronic (Internet and mobile phone based) alternative, there is a need to improve upon the methodology of conventional mail marketing operations that rely on consumption by the recipient of hard copy items. This consumption rate should be measured, as should other forms of disposition of the media that the recipient may elect.

The present disclosure provides a novel, low cost, real time, information feedback system that can report a recipient's actions and reactions to the marketing campaign operator automatically. In particular, in one embodiment, a method for determining, at a minimum, if a marketing parcel has been opened, and if the contents have been read is provided. It will be clear to those familiar with marketing analytics that there are additional types of information that may be provided in the feedback message, including time stamps of events (delivery, opening, etc.).

The present disclosure also provides a means for implementing the business method based on electronic tracking tokens that access and utilize public or private wireless network infrastructure to carry the feedback information from the recipient's location (home or office, for example) to the campaign operator's endpoint data processing location. The present disclosure further teaches how to construct and deploy the electronic token together with special sensors that are embedded in the parcel along with the wireless token. The present disclosure further teaches a person of ordinary skill in the art of electronic communications how to make and use the tokens and sensors at minimum cost as is needed to allow mass deployments. The present disclosure also teaches a new data-analytics methodology that has the capability of streamlining marketing and advertising campaigns and expenses while preserving natural resources by eliminating waste. A principal benefit of the business method is the ability to retarget and continuously optimize the parameters of the campaign based on the valuable behavioral feedback obtained, either in raw form (open rates) or refined form (data analytics employing and combining demographic, geographic and physical data about the parcels' fate).

In addition to the above use case, the present disclosure enables applications to as yet unspecified information gathering, item tracking and behavioral analytic processes as will be evident to persons interested in or in need of such processes. Adaptations of the present disclosure and the teachings herein to such applications will be possible by one of ordinary skill in the art of electronic data transmission and information processing.

Additional uses of the present disclosure derived from the primary functionality described herein are described below, to which the inventor also makes a claim of present disclosure of methods, processes and devices tailored to the additional uses.

In addition to mailings as described above, the use of the present disclosure in a magazine or similar encapsulation provides an effective and highly efficient method for “closing the loop” on advertising content delivery through advertisements in said magazines. By incorporating sensors within the advertisement itself, or multi-sensors within a plurality of advertisements, advertisers may obtain crucial consumer feedback. The types of feedback and the activation of the feedback by various stimuli (scratch off, peel off, pressure sensor or other tactile input mechanism) is limited only by the imagination. In this type of application the need for microminiaturization is lessened due to the form factor and weight of the carrying media (magazines, for example). The technology described herein may be readily partitioning into a small number of sub-modules (described further in the sequel) so that the configuration of the technology may be optimized to the application and the most efficient deployment may be realized. Another simple method for providing the technology, in a magazine application for example, is to utilize “belly bands”. A belly band includes the transponder, antenna, battery and sensors to detect removal or opening. The band can easily be added to pre-produced media such as magazine as well as to other packaging that can accept a stretch wrapper.

The sensors within the band can detect various actions. Additional sensor leads may also be provided so that internal or external sensor action can be connected to the transponder.

Parcel tracking can be implemented directly by including a tracking tag (as described more fully in the sequel) in the packaging of the parcel. Parcel tracking can be used to monitor the progress of the parcel through delivery channels. In addition, by configuring the tracking tag with appropriate sensors, the conditions to which the parcel is subjected in transit may be monitored and reported. These conditions include temperature, humidity and other ambient environmental elements, as well as conditions that may be harmful to the parcel, such as smoke, fire, harmful gas, loss of air pressure, loss of oxygen, etc. These are representative of the type of variables that may be monitored. It will be clear to one of ordinary skill that other variables may also be monitored, and that the only limit is the availability of appropriate sensors. For example, gravitational force (acceleration, or g-force) may be monitored for special applications.

Another problem that is solved by the present disclosure is the problem of asset tracking. Primary assets may be tracked in a manner similar to the tracking of parcels. Certain secondary assets are used in the warehousing and shipping of primary assets. An example of a secondary asset is a pallet. Pallets are used in transport and warehousing operations in which primary assets are loaded on pallets for movement or storage. The pallets are intended to be reusable. A problem that arises in the flow of pallets through a logistics process or channel is that there are often lost or discarded when the primary assets are unloaded. The present disclosure provides a means to track the location of pallets through their movements and even throughout their useful service life. By integrating a suitable embodiment of the present disclosure into the pallet or other secondary asset as described above, in particular an embodiment that incorporates a larger battery or an alternate renewable power source such as a photo-cell or solar-cell, the asset may be tracked, for example, on a daily basis.

In the medical field the present disclosure has utility as a tracker of medical materials. One category if such materials is live tissue and organs. It is clear that the vitality of such items depends critically on the timeliness of delivery as well as the preservation of controlled environment. Use of the present disclosure provides a method for monitoring and guaranteeing these variables.

Another application in the medical field is to medical device logistics, such as recalls. In certain cases there is a mandatory procedure for compliance with recall protocols such as may be instituted by the Food and Drug Administration (FDA). Use of the present disclosure provides verifiable compliance checking and can enhance the safety intended by any such recall.

Another application of the technology is asset tracking. Asset tracking may be important when assets are released into a logistics stream that is generally not completely specified in advance. An example is the use of pallets. Pallets are not generally the end-user item that is being transported to a given location, and they are usually expected to be returned to their owner. By incorporating a tag according to the present disclosure into a pallet, or by affixing one, the location of the pallet may be tracked and its return guaranteed, or at a minimum its likelihood of loss reduced. In this application several aspects of the present disclosure may be varied. Some of these aspects are the size of the battery and the type of enclosure/packaging that is provided. These variations do not affect the central functionality of the present disclosure, which is the use of low power radio signals carried on wide area networks to relay timely information at very low cost, unobtrusively. The same statement applies to other variations that may be made to accommodate other applications mentioned, or which may be imagined in the future.

The present disclosure teaches one how to embed certain sensor and wireless transmission technology in media parcels, or other packages, containers or transportable items as described above, that can automatically sense the opening of the parcel, the opening of the enclosed material and other recipient actions, as well as a multitude of environmental variables. The sensed actions or environmental variables are encoded into a digital feedback message that also includes identifiers that permit correlation of the reported action with the recipient address or identity (in coordination with a previously prepared database—a process called “pairing”) as well as other useful information, such as timestamps. The present disclosure teaches how to prepare the digital message in coded form, suitable for transmission by radio signals and capable of being received by publicly or privately deployed radio base-stations and propagated (forwarded) through associated public or private information networks (including the internet). The present disclosure further teaches how to efficiently encode the useful information, how to create an electronic pathway from the recipient's address to the campaign operators processing location, how to prepare reference data-bases that enable data-analytic tools and other tools, and how to extract valuable information from the accumulated feedback. The present disclosure also teaches how to manufacture media containing the intelligent tracking technology as well as how to create semi-knock-down versions of the technology in kit form so that the full range of applications may be addressed with great versatility.

The present disclosure also teaches how to fabricate electronic “tags” or “intelligent transponders” comprising the following elements: A digital processing means, a radio frequency processing means, certain ancillary electrical and electronic signal processing and control means, certain ancillary digital and computer processing and or computer programming means, antenna means, especially printed antennas, printed circuitry based on printed electronics techniques, power sources, including printed battery means and printed capacitor means as well as other power source means such as solar or photo cell means, energy harvesting means, sensor means, including environmental sensors such as temperature, pressure and humidity sensors as well as other physical sensors such as vibration sensors and orientation sensors, sensor placement and circuitry techniques. Aspect also relate to energy management techniques, methods and practices that conserve battery life and minimize call size and discloses techniques for the minimization of circuit size, complexity and power consumption for targeted applications.

In the United States the Media Mail-based marketing and advertising business is a (USD) 46 billion dollar industry. The size of the global industry is at least 10 times that figure. For over a century this industry has operated in a manner that provides only the most primitive feedback relating to the effectiveness of a given mass mailing campaign, namely, whether or not the person converted (the definition by which varies from advertiser to advertiser), and only in such events, the mailing campaign operator (or other surrogate agent) will receive positive notification of said recipient's interest in and response to the material. However, In the vast majority of cases, the media or parcel is discarded unopened, opened and then discarded, destroyed by the recipient (e.g., shredded) or allowed to remain in any one of a number of states of oblivion.

In profound contrast, in the electronic commerce and digital marketing/advertising paradigm, which is enabled by the Internet and by the concomitant profusion of personal digital electronic technology such as smart phones and wireless computer tablets, operators of digital and electronic advertising and marketing campaigns are afforded the powerful benefit of specific feedback from the recipient in the form of tracking, logging, parsing and reporting recipient's actions through the use of “cookies”, pixel tracking, and various other means. These actions include “clicking” on content, reading content, saving content, and other information that can be subjected to data analytics that reveals recipient's reaction, interest, intent and susceptibility to the marketing proffer. It is estimated that the use of these feedback techniques increases the effectiveness and efficiency (cost/acquisition of a customer) of the marketing or advertising campaign by 300 to 500 percent.

In view of the inherently blind, open-loop (no or limited feedback) nature of the conventional non-electronic mode of marketing, and in view of the immensely more effective and more efficient electronic (Internet and mobile phone based) alternative, there is a need to improve upon the methodology of conventional mail marketing operations that rely on consumption by the recipient of hard copy items. This consumption rate should be measured, as should other forms of disposition of the media that the recipient may elect.

The present disclosure provides a novel, low cost, real time, information feedback system that can report a recipient's actions and reactions to the marketing campaign operator automatically. In particular, aspects relate to a method for determining, at a minimum, if a marketing parcel has been opened, and if the contents have been read. It will be clear to those familiar with marketing analytics that there are additional types of information that may be provided in the feedback message, including time stamps of events (delivery, opening, etc.).

The present disclosure also provides a means for implementing electronic tracking using tokens that access and utilize public or private wireless network infrastructure to carry the feedback information from the recipient's location (home or office, for example) to the campaign operator's endpoint data processing location. The disclosure further teaches how to construct and deploy the electronic token together with special sensors that are embedded in the parcel along with the wireless token. The disclosure further teaches a person of ordinary skill in the art of electronic communications how to make and use the tokens and sensors at minimum cost as is needed to allow mass deployments. The disclosure also teaches a new data-analytics methodology that has the capability of streamlining marketing and advertising campaigns and expenses while preserving natural resources by eliminating waste. A principal benefit of the business method is the ability to retarget and continuously optimize the parameters of the campaign based on the valuable behavioral feedback obtained, either in raw form (open rates) or refined form (data analytics employing and combining demographic, geographic and physical data about the parcels' fate).

In addition to the above use case, embodiments enable applications to as yet unspecified information gathering, item tracking and behavioral analytic processes as will be evident to persons interested in or in need of such processes. Adaptations of the present disclosure and the teachings herein to such applications will be possible by one of ordinary skill in the art of electronic data transmission and information processing.

In addition to mailings as described above, the use in a magazine or similar encapsulation provides an effective and highly efficient method for “closing the loop” on advertising content delivery through advertisements in said magazines. By incorporating sensors within the advertisement itself, or multi-sensors within a plurality of advertisements, advertisers may obtain crucial consumer feedback. The types of feedback and the activation of the feedback by various stimuli (scratch off, peel off, pressure sensor or other tactile input mechanism) is limited only by the imagination. In this type of application the need for microminiaturization is lessened due to the form factor and weight of the carrying media (magazines, for example). The technology described herein may be readily partitioning into a small number of sub-modules (described further in the sequel) so that the configuration of the technology may be optimized to the application and the most efficient deployment may be realized. Another simple method for providing the technology, in a magazine application for example, is to utilize “belly bands”. A belly band includes the transponder, antenna, battery and sensors to detect removal or opening. The band can easily be added to pre-produced media such as magazine as well as to other packaging that can accept a stretch wrapper.

The sensors within the band can detect various actions. Additional sensor leads may also be provided so that internal or external sensor action can be connected to the transponder.

Parcel tracking can be implemented directly by including a tracking tag (as described more fully in the sequel) in the packaging of the parcel. Parcel tracking can be used to monitor the progress of the parcel through delivery channels. In addition, by configuring the tracking tag with appropriate sensors, the conditions to which the parcel is subjected I transit may be monitored and reported. These conditions include temperature, humidity and other ambient environmental elements, as well as conditions that may be harmful to the parcel, such as smoke, fire, harmful gas, loss of air pressure, loss of oxygen, etc. These are representative of the type of variables that may be monitored. It will be clear to one of ordinary skill that other variables may also be monitored, and that the only limit is the availability of appropriate sensors. For example, gravitational force (acceleration, or g-force) may be monitored for special applications.

Another problem that is solved herein is the problem of asset tracking. Primary assets may be tracked in a manner similar to the tracking of parcels. Certain secondary assets are used in the warehousing and shipping of primary assets. An example of a secondary asset is a pallet. Pallets are used in transport and warehousing operations in which primary assets are loaded on pallets for movement or storage. The pallets are intended to be reusable. A problem that arises in the flow of pallets through a logistics process or channel is that there are often lost or discarded when the primary assets are unloaded. In one embodiment, a means to track the location of pallets through their movements and even throughout their useful service life is provided. By integrating a suitable embodiment into the pallet or other secondary asset as described above, in particular an embodiment that incorporates a larger battery or an alternate renewable power source such as a photo-cell or solar-cell, the asset may be tracked, for example, on a daily basis.

In the medical field embodiments have utility as a tracker of medical materials. One category if such materials is live tissue and organs. It is clear that the vitality of such items depends critically on the timeliness of delivery as well as the preservation of controlled environment. In one embodiment, a method for monitoring and guaranteeing these variables is provided.

Another application in the medical field is to medical device logistics, such as recalls. In certain cases there is a mandatory procedure for compliance with recall protocols such as may be instituted by the Food and Drug Administration (FDA). Aspects disclosed herein provides verifiable compliance checking and can enhance the safety intended by any such recall.

Another application of the technology is asset tracking. Asset tracking may be important when assets are released into a logistics stream that is generally not completely specified in advance. An example is the use of pallets. Pallets are not generally the end-user item that is being transported to a given location, and they are usually expected to be returned to their owner. By incorporating a tag according to the present disclosure into a pallet, or by affixing one, the location of the pallet may be tracked and its return guaranteed, or at a minimum its likelihood of loss reduced. In this application several aspects may be varied. Some of these aspects are the size of the battery and the type of enclosure/packaging that is provided. These variations do not affect the central functionality of aspects disclosed herein, which is the use of low power radio signals carried on wide area networks to relay timely information at very low cost, unobtrusively. The same statement applies to other variations that may be made to accommodate other applications mentioned, or which may be imagined in the future.

The present disclosure teaches one how to embed certain sensor and wireless transmission technology in media parcels, or other packages, containers or transportable items as described above, that can automatically sense the opening of the parcel, the opening of the enclosed material and other recipient actions, as well as a multitude of environmental variables. The sensed actions or environmental variables are encoded into a digital feedback message that also includes identifiers that permit correlation of the reported action with the recipient address or identity (in coordination with a previously prepared database—a process called “pairing”) as well as other useful information, such as timestamps. The present disclosure teaches how to prepare the digital message in coded form, suitable for transmission by radio signals and capable of being received by publicly or privately deployed radio base-stations and propagated (forwarded) through associated public or private information networks (including the internet). The present disclosure further teaches how to efficiently encode the useful information, how to create an electronic pathway from the recipient's address to the campaign operators processing location, how to prepare reference data-bases that enable data-analytic tools and other tools, and how to extract valuable information from the accumulated feedback. The present disclosure also teaches how to manufacture media containing the intelligent tracking technology as well as how to create semi-knock-down versions of the technology in kit form so that the full range of applications may be addressed with great versatility.

The present disclosure also teaches how to fabricate electronic “tags” or “intelligent transponders” comprising the following elements: A digital processing means, a radio frequency processing means, certain ancillary electrical and electronic signal processing and control means, certain ancillary digital and computer processing and or computer programming means, antenna means, especially printed antennas, printed circuitry based on printed electronics techniques, power sources, including printed battery means and printed capacitor means as well as other power source means such as solar or photo cell means, energy harvesting means, sensor means, including environmental sensors such as temperature, pressure and humidity sensors as well as other physical sensors such as vibration sensors and orientation sensors, sensor placement and circuitry techniques. The present disclosure also teaches energy management techniques, methods and practices that conserve battery life and minimize call size and discloses techniques for the minimization of circuit size, complexity and power consumption for targeted applications of the present disclosure.

Other means of obtaining tracking information, such as RFID and manual barcode scanning, only give positive confirmation of delivery of the parcel and the route and timing of such delivery. No information is obtained regarding the recipient's actions. Neither is information developed or forwarded pertaining to the environmental variables that are relevant to the item being tracked. This lack of capability in the prior art is due to the absence of sensors, encoding and transmission means designed to measure targeted variables (system states) and timely deliver measured information or detected conditions or actions to a remote data collection/tracking/monitoring location. The primary advantage of the business method taught by the present disclosure is the extraction and real-time delivery of this behavioral and environmental information in feedback message form. The system is entirely automatic and requires no manual scanning by third party carriers. The system takes advantage of the emergent Internet of Things (IoT) paradigm. By exploiting IoT platforms, especially certain wireless transport networks that are currently in development and deployment worldwide (such as SigFox and LORA), the benefits of the present disclosure may be realized without the need for creating, developing and deploying extensive infrastructure. The present disclosure works in conjunction with infrastructure that is already available. The infrastructure, and the present disclosure, differs from the cellular infrastructure in that it is optimized for low power, low data rate operation.

Cellular and related infrastructure is comparatively expensive to deploy and operate and is not efficient for relaying large volumes of small disjointed (unrelated to one another) data packets from widely distributed sources. Indeed, the present disclosure entails a transmitter embedded in a media parcel, or other item that is to be tracked or monitored, actively transmitting for only a few tenths of a second (or longer if required), and, in one application described here, mass marketing mailings, this occurs only once in its lifetime. It is clear that this highly specialized communication and information flow is unlike any other communication or information carrying system. Existing wireless systems that provide large scale coverage are designed for carrying large volumes of data from recurring usage instances (such as cell phone calls, video streaming, etc.) and the cost of such systems is shared by and amortized over recurring user behavior. In the present disclosure the network capacity is accessed by a much higher geographical density of distinct transmissions, but each transmitting element is only used once, or, alternatively, is used a limited number of times for short durations, or even an unlimited number of times but at a very low percentage of the time (as in the tracking of non-perishable assets).

Other approaches can be envisioned. A campaign operator can follow up a mailing with a phone call campaign or even a physical visit to the recipient to “survey” or “poll” the recipient population. This is neither thorough nor efficient, and is definitely not automatic or unobtrusive. Solutions that borrow elements from the present disclosure but that do not employ certain key elements may also be compared. For example, it is conceivable that the present disclosure could be adapted to interact with cell phones or even the conventional telephone network, perhaps automatically. In the case of cell phone based operation of the present disclosure, the technology costs would be higher because the parcel sensors would be required to communicate with the cell phone using cellular frequencies. Cell phone signals are more complex and require an FCC license to transmit.

WiFi and Bluetooth signals are another option but they have limited range. They are also more complex that the signals needed for the present disclosure, making the electronics more expensive. The present disclosure teaches how to relay the feedback message over a distance of miles without the need for intervening user equipment, such as a cell phone or WiFi access point. Moreover, the message is transmitted, according to the present disclosure, using a signal of minimal complexity, making the signal generation and transmission technology (circuitry, firmware and software) simple and inexpensive.

In applications in which the response of a recipient of a marketing or advertising offer or related material is of primary interest, the present disclosure provides behavioral information about the recipient, not merely delivery information. Furthermore, the present disclosure does this in real time, sending the feedback message immediately upon being handled (opened, read, torn, etc.) by the recipient.

In applications in which the intention is to track the progress of an item through a delivery or other logistics or distribution channel, the present disclosure provides the ability to provide tracking in fine detail, at any desired granularity and frequency, automatically without manual operation of any scanning or similar means to register the item's location.

In applications in which it is desired, required, or otherwise necessary to guarantee the environmental conditions through which an item is passed as it progresses through a delivery, distribution or any other logistics channel, the present disclosure provides the capability for real time automatic monitoring and reporting of critical environmental parameters such as temperature, humidity, pressure, shock (g-force), and vibration. It is also possible to monitor the absolute orientation of an item in transit in case it is desirable to maintain a particular orientation, such as “this end up”. Packaging can also be outfitted with the present disclosure configured to operate in a manner that indicates the loading of items in situations where “stacking” limits are in place (such as “do not stack more than 10 high”).

The foregoing descriptions, formulations, diagrams, and figures are provided merely as illustrative examples, and they are not intended to require or imply that the steps of the various embodiments must be performed in the order presented or that the components of the present disclosure be arranged in the same manner as presented. The steps in the foregoing descriptions and illustrations may be performed in any order, and components of the present disclosure may be arranged in other ways. Words such as “then,” “next,” etc., are not intended to limit the order of the steps or the arrangement of components; these words are used merely to guide the reader through the description of the present disclosure.

Although descriptions and illustrations may describe the operations as a sequential process, one or more of the operations can be performed in parallel or concurrently, or one or more components may be arranged in parallel or sequentially. In addition, the order of the operations may be rearranged.

Intelligent Transponder

The intelligent transponder is a self-contained component (that is, it is part of a larger data processing paradigm that includes the transponder, radio network elements, data forwarding means such as a data network or the internet, host computers, storage computers, databases, and data analysis and reduction software) of a Tracking and Reporting System comprising a battery or other energy storage element, digital circuitry, analog circuitry, radio frequency (RF) circuitry, an antenna, one or more sensor elements or sensor circuits and, optionally, an RFID element. These elements of the transponder may be fully integrated into a single package or may be left in a semi-knock-down form allowing multiple configuration options.

The overall operation of the system may be understood with reference to the following exemplary application, which is to obtain useful information about the disposition of a marketing or advertising mailing delivered (or intended for) to a specific recipient. The steps indicated capture the essential operation of the present disclosure. Modifications or additions to the steps, such as the addition of triggered reports of certain events (temperature over limit, for example), will be clear to one of ordinary skill in the art.

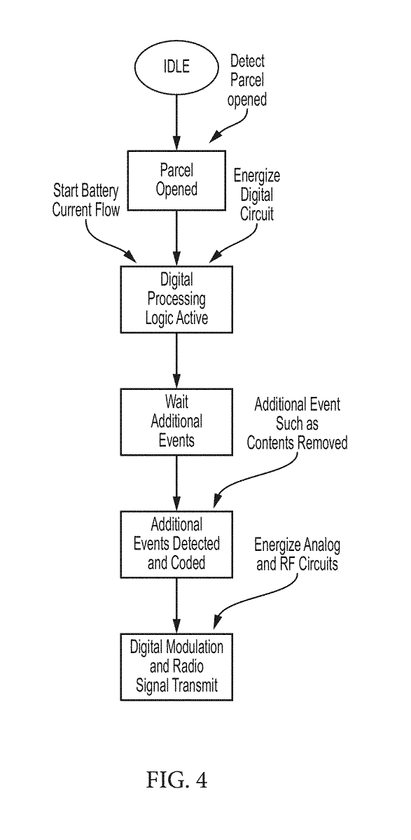

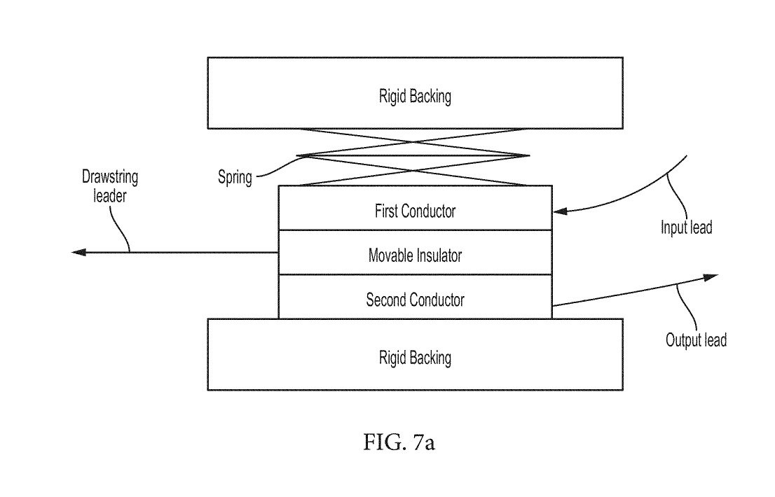

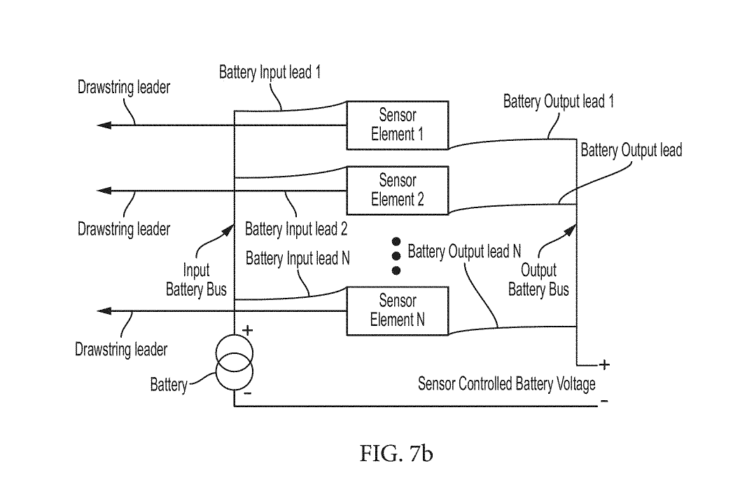

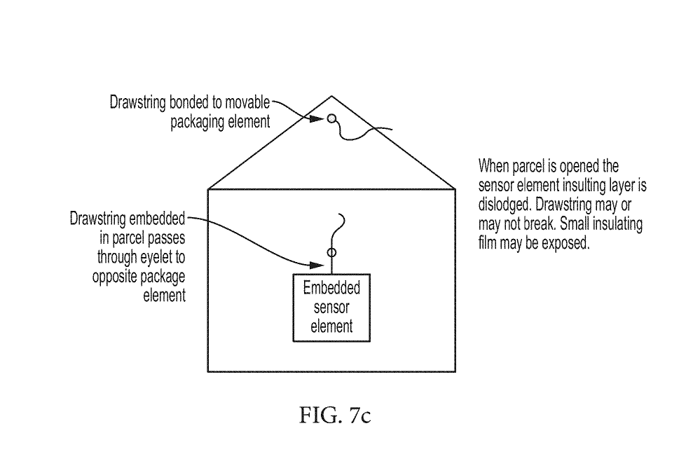

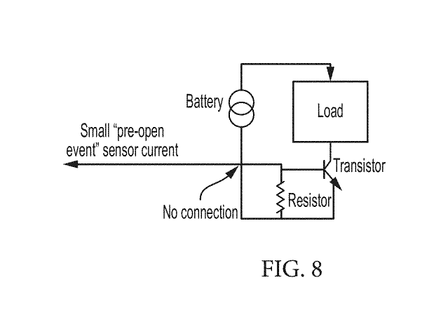

FIG. 4 shows a flow chart for the intelligent transponder operation when the system is configured to detect only “parcel opened”. More complicated logic involving multilevel event detection such as “contents removed” are straightforward extensions of the teachings of FIG. 4 and related text. FIGS. 7a-7c and 8 show variations in which the system is configured to detect the secondary event “contents” removed. In one embodiment, a timer or clock may be used to detect timeout events. Other events that may be of interest, assuming appropriate sensors are included.

The sensor circuits are embedded in the parcel in the form of conduction paths consisting of fine wire or printed conducting material. The primary sensor is configured to close a circuit when the parcel is opened, that is, when the external packaging is opened to access the contents within. Additional sensor circuits are optionally included that can detect the removal of the contents from the packaging. The latter sensor elements operate by breaking the circuit established by the primary sensor means. Thus there is a conditionally executed process involving the second sensor: It only functions if the parcel is opened. Of course, it is not necessary to determine that the contents were not removed if the parcel is not opened.

Upon detection of the “parcel opened” event the flow of current creates a voltage across a sensing resistor that in turn wakes up the digital processing circuitry.

The digital processing circuitry may be thought of as a special purpose computer. In implementation, it may consist of a software controlled microcomputer that executes a stored program. This viewpoint is useful for understanding the operation of the intelligent transponder. However, an equivalent functionality is possible using an implementation that is based on a small state machine or micro-coded bit slice processor. The latter will execute the same sequence of control operations as a software controller (microcomputer) but at potentially smaller cost of battery (or other stored energy source) power and without the cost of the microcomputer itself.

In an optional configuration of the present disclosure, with added capability, a clock circuit may be included in the transponder. If this is done it may be necessary for the battery to supply energy to said circuit even before a trigger event occurs. Such circuits can be made to consume extremely small amounts of energy. In this optional configuration, the transponder will again wake up when the primary sensor is activated. In another case, the system would wake up in the event of a timer reaching a certain state.

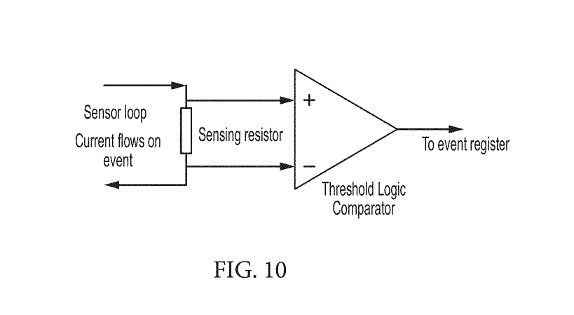

There are other triggers and events that may be identified by the intelligent transponder. These will be described after the basic operation, triggered by the “parcel opened” event, is described. Here it is only necessary to understand that the various sensor circuits, and the events they are designed to detect and identify, produce unique patterns of current and voltage that may be converted to binary coded information tokens called event codes. There are numerous electronic circuit methods for sensing such voltage and currents, one of which is exemplified in FIG. 10.

Another way to detect different events is via multiple I/Os at the controller, which are related to different events. Thus the events would be I/O mapped. They could also be mapped into interrupt vectors. These are standard alternatives to communicating external states, phenomena and actions to a process or processor and will be familiar to one skilled in the art.

When the digital processor is activated by the “parcel opened” event the binary code produced by the sensor is used to construct a pointer that instructs the control processor how to assemble a message. This instruction can be processed either as a program jump in a software implementation or as a pointer (address) to a memory location from which the appropriately coded message element is retrieved. The latter method has the benefit of using low cost memory circuits rather than requiring a processor to build the element “on the fly” from primitive instructions. In case the system is configured to detect the “contents removed” event, the processor will enter a “wait” state so that the second event may be detected before the final message element is selected or assembled.

The message element is a binary sequence that identifies the event. Although there are only a small number of events defined, and hence only a few bits of information required, it is advantageous and recommended that the event codes be further expanded by means of well-known error correcting coding methods.

One such coding method, which is exceptionally simply, is simply repeating the information bits a number of times. For example, if each bit is replicated 3 times, it is possible to detect a single bit error by simply majority logic. More powerful error correcting codes are also well known, such as BCH codes, and would be natural candidates for use in at least some embodiments described herein. If the message elements are pre-stored in memory the use of more complicated codes than the repetition code just described is straight forward since the encoding is done in fabrication of the transponder memory (that is, the message code is hard coded). In either case it will be clear to one of ordinary skill in the art that the use of codes will enhance the performance of the system and that there are many coding schemes available in the literature to choose from.

Once the parcel events, if any, have been deemed to have run their course the next step is to transmit a radio signal. One case is very simple: No event occurs (the parcel is never opened), and there is no timer expiration mechanism enabled. In that case no signal at all is generated or transmitted. In any other case (except destruction that renders the radio inoperable) the radio signal will be transmitted. The transmission of the radio signal occurs upon applying power to the baseband processor circuit and to the radio frequency circuit. The radio signal is formatted to include a field of binary information containing the feedback message payload. The feedback message payload itself contains the unique address code of parcel, or an encoded equivalent thereof, the message element identifying the parcel event, and the address of the terminal processing computer or an encoded equivalent thereof. As is discussed elsewhere in this description of the present disclosure, there are multiple methods of correlating and encoding or programming the transponder and/or management database (which contains the recipient data, among other things) to create a unique digital map between the transponder and the recipient's address. As with the parcel event code, it is advantageous to employ error control techniques to these fields of data as well.

The radio signal also includes a short header and or preamble field that may be used by the wireless network for synchronization and identification purposes. An additional non-information bearing stabilization preamble may also be provided so that the radio frequency circuits have time to stabilize before the information bearing portion of the radio signal, i.e., header, preamble, and payload, is passed through the circuit.

Once the composite binary signal is prepared, the modulation process is applied to it to create a radio frequency signal. The modulation process is specific to the radio network employed. There are numerous modulation processes to choose from. The one that is described here is typical. Any other modulation process can be supported and would be effective in realizing the present disclosure so long as it is compatible with the wireless transport network the system is operating on. It is well known in the art how to create modulated digital communication signals and one of ordinary skill in the art can readily adapt the teachings herein to accommodate any of them.

One example of a suitable wireless network that is available at the time of the present disclosure is the SIGFOX Network.

A feature of the present disclosure is the use of multiple transmissions to ensure the feedback information message is correctly processed. This is not intended to be a limitation but rather an embodiment. To use this feature the control processor may be configured to transmit the radio signal repeatedly. It is also possible to program the processor to stagger the repetitions of the radio signal transmission so as to minimize burst traffic overloads on the wireless network. However, it is a feature of the present disclosure that the traffic generated by the system is of very low volume and it is likely that the wireless network can easily accommodate a burst of continuously repeating transmissions that lasts a fraction of a second.

The Pairing Process is the process of associating an individual transponder with a recipient or asset owner. The process is similar in the two cases, and is described next. To be specific the process of pairing with a recipient is described.

The intelligent transponder includes within it a means for programming information that is specific to the intended recipient, which may be a postal address or other unique recipient identifier. Recipient identification data is made available to the receive message processing platform, which will translate transponder received messages into information legible and useful to end users of transponder information. The means for transponder recipient data programming can be implemented as part of the manufacturing of the transponder circuit, in which case the programming would be coupled to a database that interworks with the transponder manufacturing process. In such cases the transponder may be loaded during manufacturing with a generic but unique identifying code that will be transmitted as part of the modulated signal.

During manufacture, and after the point in time when recipient-specific data for a particular transponder becomes known, the transponder unique identifying code may be stored in the database together with the associated recipient-specific data, for later use by the message processing platform. For this time-of-manufacture method of programming, the transponder unique identifying code may be accessed via optical scanning or electrical interface, or other means convenient and suitable within a mass production environment.

Alternatively, the programming means may be arranged in a manner that allows the transponder to receive digital information wirelessly by being placed in the field of a programming instrument. Still another method of programming, which utilizes a reverse process, is to provide the transponder with a passive identification emission means, similar to RFID, in which the transponder emits its unique (built in at manufacture time) identification code. The emitted code is uniquely associated with the physical address of the intended recipient. In this method of programming, the return address (the address of the terminal processor) would be built into the transponder.

The components of the present disclosure, in an embodiment, are described below. Different components are indicated for different applications so that the many varied embodiments of the present disclosure may be appreciated. These components are intended to support the operation of the present disclosure, but some may be considered optional or unnecessary in simplified applications. Thus, for example, in direct mail marketing or advertising applications, if there is only one event of interest, such as “parcel opened”, then there is no need for an event decoder or encoder or register, or other “mapping” means to map the detected event to an action to be relayed or reported by the transponder. Inclusion of components in the description of the embodiment is meant to be inclusive, not exclusive, and not implying any necessity or presence when such presence is superfluous. On the other hand, the description is intended to teach the various elements of the present disclosure in general so that adjustments for the sake of simplification may be made intelligently.

An intelligent transponder that may be embedded in a mail or shipping parcel, or in a container or specialized transport medium (such as in an organ transplant scenario). An intelligent transponder may also be incorporated (integrated) directly into shipping, mailing or transportation packaging or containers, such as cardboard boxes or any similar container. In addition, the intelligent transponder may be built into an asset, such as a shipping pallet or transport case.

The intelligent transponder, or transponder assembly, comprises a digital processing means, which may be either a discrete specialized circuit driven by state machine logic or a software (micro-coded) driven logic circuit or a general purpose microcomputer; a sensor means that functions to detect and identify certain specific events that occur upon the parcel being received at the addressee's location, or events prior to such receipt such as water damage or other destruction, the said specific events including opening of the parcel external enclosure, opening of the parcel's internal contents, tearing or shredding the parcel, or other actions a human recipient may perform or cause upon receipt of the parcel; additional sensor means for measuring and or monitoring environmental parameters such as temperature, pressure, humidity, moisture, and other meteorological variables; additional sensor means for detecting, measuring and or monitoring other physical parameters or conditions, such as shock force, g-force (acceleration), vibration, orientation faults (upside-down/right-side-up, vertical/horizontal, stacking load/height; a battery for powering the intelligent transponder for a short period of time (it's active lifetime), or, in some applications, providing power for the required amount of recurring operation time, which may be as long as desired according to the battery size; alternate power sources such as photo-cell or solar-cell or other energy harvesting means (ambient light, vibration (such as piezo-electric), electromagnetic fields or other energy laden phenomena from which energy may be harvested); ancillary energy storage means such as “super-capacitors” that permit energy delivery from a source such as a battery to be tailored or conditioned in a manner that permits the primary energy source, such as a battery, to be small while the electrical circuit elements remains operable under peak energy, power, voltage or current demands, said peak demands being of a duration consistent with the capacity of the ancillary means; means for delivering energy similar to the ancillary means of the preceding sentence, except that the means may be provided as primary means in certain applications, for example, applications in which a super-capacitor is charged prior to deployment of the present disclosure so that its stored energy may be available and drawn upon downstream in an applicable process; a timer or clock means for providing relative or absolute time or time interval information; an encoder means that encodes the sensor events and other information, such as address or time information, or environmental or physical condition information (such as orientation or vibration) into a binary data format that also may include elements that enable the integrity of the data to be ensured, enhanced and measured after transmission through a radio channel that may impart errors (i.e., error control code elements); a radio frequency transmitter comprising a discrete digital signal generator (formatter and level shifter or voltage generator that accepts binary data from the encoder) which is coupled to a modulation means for creating a modulated radio carrier, amplifier and filtering means for conditioning the radio frequency carrier for transmission, and coupling means, including impedance matching, for efficiently coupling the modulated radio signal to an antenna; an antenna that is embedded conformably in the parcel container, such as a printed conductor or embedded conductor in an envelope or other package; or an antenna that is configured to be enclosed in or attached to a container or asset and which includes means of connection to an RF signal source, or an antenna that is printed together with other elements, such as circuit elements and battery, to form a single “tag” or “card” or “flexible part”; optionally, a redundant antenna for the provision of radiation directed in more than one direction of signal propagation; a switch or commutator or multiplexor means for the switching, dividing or combining of signal energy between plural antennas, if present.

The intelligent transponder also includes within it a means for programming information that is specific to the intended recipient. This process is called “pairing”. The programming means and or the programming process itself (pairing process) may be implemented as part of the manufacturing of the transponder circuit, in which case the programming would be coupled to a data base that interworks with the transponder manufacturing process. Alternatively, the programming means and or programming may be arranged in a manner that allows the transponder to receive digital information wirelessly by being placed in the field of a programming instrument. Still another method of programming, which utilizes a reverse process, is to provide the transponder with a passive identification emission means, similar to RFID, in which the transponder emits its unique (built in at manufacture time) identification code. The emitted code is uniquely associated with the physical address of the intended recipient or uniquely associated with the serial number of an asset, or uniquely associated with any other identification required for the application in which the present disclosure is operating. In this method of programming, the return address (the address of the terminal processor) could be built into the transponder. A further variation of the above means is an externally readable serial number, which may be printed on the transponder substrate for example, that provides the identification coding and which may be input to a separate automatic or manual process of pairing.

It will be appreciated that the present disclosure has many potential applications and these various applications may collectively entail significantly distinct physical “form factors” such as size, weight and power requirements without changing the essential elements of the present disclosure. In view of this diverse application spectrum it will be appreciated that the present disclosure may be embodied in a single highly integrated package to minimize size, weight and power requirements, as well as cost, or that the present disclosure may be provided in “semi-knock-down” (SKD) form, in which case the components of the present disclosure are separated into major blocks, such as the RF electronics module, battery/power source, antenna, sensors. These blocks may be adjusted to accommodate various applications consistent with the present disclosure. For example, the power source for some applications, like pallet or container tracking, may be made larger so that the usable active life of the transponder matches the pallet/container lifetime or in-service time interval. In other scenarios, such as direct mail, the power source may be made very small, consistent with the application only entailing a small number of active operating/transmission intervals. Further examples of alternative configurations and configuration management and optimization, will be readily appreciated and realized by persons of ordinary skill in the art.

A radio network capable of receiving, demodulating and decoding the radio signal emitted from the intelligent transponder, extracting the information carried by said signal (the feedback message payload) and transferring the decoded payload via a digital network interface to a digital carrier network, such as the Internet or other digital network capable of routing digital information (such as data packets), which is further configured to forward the feedback message payload to a terminal processing means under the control of the marketing campaign operator, or, more generally, any entity engaged in item monitoring and tracking and recipient behavior analysis.

A terminal processing means, such as a computer, that is specifically configured to receive and analyze the feedback message information and compile various valuable data analytics associated with the parcels whose signals have been successfully transmitted and forwarded to the terminal. The terminal processing means contains all data and database processing necessary to administer the campaign and the recipients' transponder reports. In addition, as part of the terminal processing, embodiments employ an application interface (API) that is specific to the wireless network in order to perform the information retrieval from the network. In particular, if the network does not provide delivery of the feedback message to the terminal processor via standard network (e.g., Internet) routing techniques (such as IP address, etc.), but rather stores the recipients' feedback datagram or datagram contents in a storage buffer, a method (utility or API) is provided to retrieve said contents from said storage at the terminal processing point or some other convenient transfer point.

The steps of operating the present disclosure are described next. It will be clear to one of ordinary skill in the art that the following steps may include some steps that are not necessary in certain applications. It is also clear that some steps may occur in a different order than the order of the following list.

1. Programming of the intelligent transponder(s) to carry encoded (encrypted or plaintext) information indicating the address to which the parcel is being sent, mailed or delivered (pairing), indicating the database addresses to which information is to be returned or delivered, indication the service profile of the deployment of the present disclosure according to the needs of the application and indicating any additional actions or exceptions that may be required in the course of the deployment, these programming contents and elements being in the form of software code (machine code) that is executable within the transponder, or, alternatively, in the form of configuration mapping information that produces the desired operation of the transponder by instantiating one or more functions that are available within the transponder and which are selectable via the described programming. In the latter case, the transponder is manufactured with preset capabilities that are available via programming according to the application. In more detail, for the purpose of exposition and illustration, the programming step includes associating the physical address of the recipient with the physical device in a manner that ensures that the transponder code for the physical mail address matches the actual mail address on the parcel so that the feedback information message correctly reflects the address where the parcel was delivered and processed by a human (processing which may include ignoring the parcel). Programming also includes, if the option is used, setting timers or time of day (absolute time) in the intelligent transponder. Finally programming includes, if not hard-coded into the transponder already, setting the address, such as a IP address, of the terminal processing computer to which the feedback information message is to be forwarded by the radio network and subsequent digital network means.

In one embodiment, the programming of the intelligent transponder can operate “in reverse”. In this embodiment, the transponder would be equipped with a means of transferring its built in electronic identifier to an external device (such as an RFID reader). The external device is configured to read the transponder's electronic identifier and associate it with a particular physical mailing address. In one embodiment, the transponder and the physical mailing address are sequenced synchronously, including automatic sequencing in a bulk mail preparation facility, in a multiple transponder configuration process.

In addition, the intelligent transponder, in some embodiments, is programmed to perform various sensing, monitoring and reporting functions at prescribed intervals and frequencies. Such programming would, for example, set the frequency of temperature reporting if a temperature sensitive item is being tracked. As another example, the temperature threshold for which such monitoring should generate an alarm and report would be programmable.

In one embodiment, the programming is performed using a very simple serial interface in which a bit sequence is applied to the processing element through an input-output (I/O) terminal. Devices can be manufactured with the capability of supporting any of a plurality of applications. The multiplicity of capabilities is described by the types of sensors available in the application deployment, while the logic that controls the reporting is described by internal digital logic that is configurable through either manufacturing parameter settings (hard coding) or through the aforementioned serial I/O port. In certain embodiments the multiplicity of sensor types and configurations, especially the external sensor circuitry, is managed separately from the multiplicity of reporting and monitoring settings. The reporting and monitoring settings may be controlled through digital logic. When the digital processing element of the transponder is programmed, the bit pattern input on the serial port induces, or instantiates, a particular configuration of the control logic inside the chip (digital circuit). This configuration can be stored in memory, and the particular configuration selected via a memory address or offset or block of addresses.

In another embodiment, the programming of the digital control can be based on finite state recognizer technology. This type of programming is useful when it is desired to make the transponder especially small. In particular, the digital processor may be designed without a software processor, thereby reducing cost and complexity of the digital subsystem. Finite state recognizer technology is known in the art of computer engineering, especially in the art of compiler design. In short, this technique operates by accepting a string or stream of tokens (in some embodiments of the present disclosure the tokens are simple binary symbols represented by voltages or currents injected through an I/O pin or terminal or port) and sequentially processing said string or stream in order to “parse” the “string sentence” into meaningful directives. Such a stream processing means can be realized by defining certain bit patterns that are recognized and which cause a state machine to transition into desired control states. In one embodiment, the state can be a pointer to a segment of microcode. In another embodiment the state can be a register word that controls selected primitive functions that are predefined at device (chip) manufacturing time but which are only instantiated as a result the programming. It will be clear to one of ordinary skill in the art of computer programming, especially microcontroller and similar device programming (firmware programming), that the above method can be designed in a manner that removes the need for a resident software control program and associated general purpose processing elements (CPU, memory, etc.). The benefit of this type of design is minimization of chip complexity (gate count, logic blocks, number of transistors, etc.) and power consumption.

In another embodiment, which is at the other end of the complexity spectrum but which is somewhat more standard art, programming of the intelligent transponder is achieved by simply loading a program file into a transponder that is equipped with a CPU and memory and any peripheral (such as I/O) components need for general purpose computer operation. In such an embodiment no special logic design aimed at minimization of logic complexity is required. The system logic is resident in the externally created control program. Such embedded system programming is also well understood in the art of digital systems design and related art.

2. Embedding the intelligent transponder within the packaging, wrapper or envelope carrying the targeted recipient materials (marketing offers, surveys, subscriptions, giveaways, advertising, goods, etc.). In another application the transponder is attached to or fabricated with the item being tracked as an integral part or element. The sequence of operations in the first two steps may be reversed or partially interleaved. That is, envelope or other packaging may be pre-configured to contain the embedded transponder, which is then programmed while in the packaging or envelope. Further variations on the sequence of operations can include programming of the transponder after the parcel has been filled with the previously described target recipient information. It will be clear to one adopting the teachings herein that there are many ways in which the process may be implemented and that a particular implementation will be dependent on cost considerations and other economics as well as deployment constraints and logistics.

3. Introduction of the parcel into the carrier outbound stream (such as the postal service, UPS, Fedex, Postmates, Amazon, Uber, and other local and autonomous delivery options) using any standard operations for “delivery” or “shipping” or “mailing” or “bulk mailing” or “direct mailing”. In a different application, such as asset tracking, the transponder equipped asset is put into service in the normal way, with the transponder activated. Subsequently, the transponder will issue tracking and monitoring reports via automated radio frequency emissions according to the programming in place. In an alternative embodiment or operational mode, the transponder may be deployed in a deactivated state and activated upon the occurrence of certain events or triggers.

4. Delivery of the parcel to the targeted recipient's physical address or location, or, motion of an asset through a transport or logistics channel. This is the monitoring and reporting portion or segment of the operation.

5. Information generation: In certain applications, human action upon taking delivery, either actively or passively, of the parcel causes information to be generated by recognition (sensing) the human action. Actions may include no action (the parcel is never opened), open and discard, open and examine/read the contents, shred or tear, burn, or any other informative behavior that the operator deems worthwhile and valuable. It is clear that any basic human action similar to those listed that can be effectively detected and identified utilizing appropriate sensors within the intelligent transponder can be considered interesting and useful behavior, which the present disclosure teaches one of ordinary skill how to measure, deliver and analyze. In other applications, such as tracking, information is generated according to a programmed schedule and includes the results of measurements such as temperature measurements, and other measurements as have been previously mentioned. In another mode of operation information is generated simply by transponder emission of a radio signal at programmed intervals, said emissions being detected by the fixed radio network which can use the detected signal to identify the location of the transponder, and, thereby, the location of an asset being tracked. This location information can be derived simply from the known location of the receiving radio network station, or stations. More sophisticated estimation of the location of the transponder may also be implemented, such as by employing trilateration (or multi-laterartion) methods. In another embodiment, GPS may be used to derive precise location information within the transponder.

6. Activation of the intelligent transponder upon occurrence of the human action, such as opening the parcel, or upon occurrence of another trigger, such as water or fire detection (which may also occur prior to any human action by the recipient), detection of a physical condition or parameter value, such as temperature, over a preset threshold, reaching a particular absolute clock time on the clock contained within the intelligent transponder, or the expiration of any timer included within the intelligent transponder.

7. Generation and transmission of a feedback information message by the radio signal generation means within the intelligent transponder. This step is triggered by an event or by a time condition and is repeated a number of times, the number being programmable. The number is dependent on the required reliability of the feedback message as measured by the probability of the message being correctly received and decoded by the radio network.

8. Reception, demodulation and decoding of the radio signal carrying the feedback information payload by the wireless network.

9. Forwarding by the wireless network of the decoded information payload to a digital carrier, such as the internet, utilizing the terminal processing computer's digital address (such as an IP address).

10. Reception, logging and either storage or processing of the feedback information at the terminal processing computer. If stored, the information is accessed by secondary access means, such as downloading or physical file access at the terminal computer, and moved to a processing location or means, such as another computer. Processing includes determining the disposition of the parcel at the particular recipient address, as detected and identified by the sensor/intelligent transponder, as well as, optionally, the timing of events from the time of insertion into the outbound stream until the human recipient's final action or until the item being tracked or monitored reaches its final destination. Processing of the ensemble of received feedback information messages, that is, the plural received messages from a plurality of targeted recipients, is also conducted. This second layer of processing includes data analytics and statistical processing intended to extract information from the population of targeted recipients or from the entire flow of items through a logistics process.

11. Data analysis at the terminal. This step entails compiling the behavior statistics on an ensemble basis utilizing the population response data as a sample as well as determining specific addressee response to the parcel and its contents. Specific addressee information is then further utilized to perform targeted follow-up marketing activity toward the specific recipient or to otherwise tailor the targeted recipient population.

The programming of the parcel/transponder combination prior to insertion of the parcel into the outbound (mail or logistics) stream is directly related to the processing by the terminal processor. In particular, the programming enables the correlation of the received feedback information, especially the disposition of the parcel by the recipient, with the particular targeted recipient in a unique one-to-one corresponding fashion. This programming is effected by utilizing various data bases that are available to the operator of the marketing or advertising campaign.

The intelligent transponder is directly related to, and is designed to be compatible with, a wireless network. In particular, the transponder generated signal may be be designed to be recognized by the wireless network and have a format that permits said network to demodulate and decode the information carried by the signal. There may be more than one layer of information coding and or formatting applied to the feedback information message. One layer of coding and or formatting will be dictated by the wireless network operator and associated signal specifications provided by said operator. Additional layers of coding are applied to enhance and or measure end-to-end message integrity, from the point of specific recipient behavior encoding by the transponder to the point of terminal processing. From the point of view of the wireless network this additional layer or layers of coding is simply user data.

The sensor element(s) and the packaging and embedding of the transponder into the parcel container (envelope or other packaging) are related to the extent that the packaging contains the sensor element (wires or conductive traces). The manufacturing of packaging according to the teachings of the present disclosure entails embedding the sensor in the packaging in a manner that permits detection of events such as “parcel opened”. Additional sensors attached to the contents of the parcel packaging, such as sensors intended to recognize secondary actions of the human recipient, such as unfolding and reading the enclosed parcel contents, are also related to the primary sensor function “detect parcel open” as well as the insertion process by which the content is inserted in the packaging. In particular, a connection to the packaging is provided between the contents and the packaging so that the removal of the contents, a human act indicating potential interest, is detectable by the package embedded transponder sensor logic.

In applications in which the purpose of the technology is tracking and monitoring, sensors are included according to the parameters that are of interest to track or monitor. The various sensors in general will be specific to a particular parameter, such as ambient temperature. The sensors will produce and encode discrete values. Alternatively, the sensor may produce the parameter value (voltage) and a conversion to a digital value may be necessary. In a multi-sensor configuration the respective sensors/parameters will be characterized by a digital identifier so that the parameter monitoring report can be read. The identifier can be a simple sequence number, but in some cases a more general identifier may be employed. This can occur if multiple sensors operate asynchronously or multiple sensor reports are generated.

The present disclosure teaches how to detect, feedback to and interpret by the campaign operator (or any agent employing the teachings of the present disclosure) several conditional transactions using physical sensor means as well as “if-then” logic. The primary function of the intelligent transponder is to detect and report the opening of the parcel packaging, an event differentiated from not opening the parcel and simply discarding it. This is the primary conditional transaction in the direct mail application, which serves to activate the radio transmission process. It is to be noted that this is not intended to limit the possible events that can trigger the radio transmission process, which can also include detection of wetness or expiry of a timer or other triggers that have been described previously. As has been explained previously in this description of the present disclosure, the radio transmission process entails certain decoding of the sensor state and preparation of a digital message carrying the decoded interpretation of the conditional event.

The following exemplify, but do not necessarily exhaust the possible cases, the events, decisions and steps to be taken in accordance with the present disclosure.

1. Parcel opened. This event may be given additional attributes, such as opened intact or opened “damaged” according to the complexity of the sensor means. In any case, this event produces a trigger, by causing a current to flow for example, that “wakes up” the parcel-embedded transponder circuitry. The awakened circuitry and logic therein is configured to detect and recognize a pattern or path of current flow that is unique to the “parcel opened” event. Such detection and recognition ultimately results in an electronic logic signal that may be stored in a binary information register. The contents of such a register are the sensor logical bits that are the core information elements that are of interest. The recognized event in turn results in the digital logic circuit assembling or retrieving a pre-stored message element for inclusion in the radio signal payload. The said message assembly process can be performed in the transponder or in advance. In the latter case, the message would be stored, one message for each interesting sensed behavior or event, within the transponder logic or memory for retrieval at the time of the radio signal generation. The radio signal payload is configured with a predefined format that is able to accept the said message element or elements.

2. Time-out event. If configured with a timer means the transponder will detect either the passage of a preset amount of time from the time of dispatch of the parcel or will detect the arrival of a particular preset absolute (calendar) time. This event will also wake up the radio signal generator means and cause an appropriately coded message element to be assembled or retrieved and inserted into the signal information payload.

3. Contents removed. This event requires a two tier sensor arrangement. The primary sensor detects the event “parcel opened”. A second sensor arrangement, such as is exemplified by the inclusion of a fine wire circuit connected between and or through the parcel contents and the packaging embedded transponder circuitry, detects the removal of the parcel contents by sensing a break in the circuit current in the second sensor wire. In this secondary event, the conditional transition “parcel opened” is used to establish the secondary sensor current in order to subsequently detect the event “contents removed”.

4. Parcel damaged. This case includes fire, water or other physical damage to the parcel, either deliberate (recipient shredding or tearing) or incidental. It also pertains to the use, for example, of in some embodiments in the shipping of perishable items. In this alternative application, illustratively, the parcel can be equipped with temperature sensors that trigger alert messages (radio signals) in case of temperature outside of safe range. In this event the transponder is again awakened by the sensor produced current flow and, as in the other illustrative cases, assembles or retrieves the appropriate feedback information message element and embeds it in the radio signal payload.

5. Parameter value reporting includes an entire class of events in which the present disclosure is used to monitor conditions. For this functionality, reports are generated and transmitted based on timing or based on values of the parameters.

End to end data integrity. In the event the transponder is triggered to emit a signal there are, in some embodiments, end to end codes provided that enable the correction of transmission errors (error control codes, also known as forward error correcting, FEC, codes, including BCH (Raj Bose, D. K. Ray-Chaudhuri, and Alexis Hocquenghem) codes, Reed-Solomon codes, convolutional codes and others as will be familiar to those of ordinary skill).

These codes are also able to detect error conditions that are not correctable. This is a form of conditional transaction that causes the interpretation of the feedback information to be modified. For example, if the feedback information payload is received with recipient address identification code deemed intact, per the FEC check process, but the event code damaged or in error, the operator of the campaign may still infer that the parcel was opened with a calculable probability, rather than damaged by fire, for example. There are many statistically meaningful information extraction possibilities associated with receipt by the terminal processor of a partially correct feedback information payload. Another example is that the address code is errored, but the event code is intact. Then the operator may still count the parcel as “opened” in calculating the overall “open rate”, a primary statistic provided by the methods of the present disclosure.

Intelligent Transponder

The intelligent transponder should be designed for minimum size, weight and power consumption. This will allow the Intelligent Transponder to be manufactured at minimum cost. In order to achieve this, custom circuitry as described herein may be employed. Two different configuration management strategies may exist. In one strategy, appropriate for mass mail campaigns as described previously, one embodiment is a single “tag” that integrates the digital and RF circuitry, the antenna, the battery and any sensor interface circuit or the sensor itself. This single piece design provides minimum size weight, power consumption and cost. In a second strategy, in which one or more of the size, weight, power or cost variables is less critical, the technology is built in a kit form (semi-knock-down or SKD) comprising four major elements: the digital and RF processor, the battery, the antenna, the external sensors. Note that in some cases the sensor, such as a temperature sensor, may be integrated with the digital and RF circuit. This second configuration management strategy is aimed at flexibility in tailoring the operation of the present disclosure to various applications. One particular aspect of the present disclosure is the use of “printed electronics” to create the electrical circuitry associated with the transponder. Printed electronics permits the transponder to be lightweight and flexible. By printing circuitry, battery and antenna elements using a single process, or a small set of processes arranged to create desired characteristics, the transponders may be produced in large quantities using automated high-volume manufacturing equipment.

The elements of intelligent transponder are the battery or other energy storage means, including, for example “super-caps”, signal generator, RF modulator, antenna, clock and various sensors and associated circuitry.

The battery or energy source may be a printable element based on simple non-toxic chemistry, such as carbon-zinc, or another compound that is able to be disposed of safely without special handling. Printing can be arranged so that the printing substrate (fabric) is compatible with the handling of the parcel containing the transponder. Thus, printing on semi rigid substrates such as circuit boards may be appropriate when rigid packaging and transponder construction is used. In other embodiments, the printing may be applied to fabrics that are flexible, such as Mylar.

The antenna is a simple loop or dipole formed from a length of conductive material or dielectric material. The shape and composition of the antenna will determine its radiation behavior, including the directivity and gain. It is advisable that the antenna be non-directional so that transmission to a base station does not depend on the particular position or orientation of the parcel or its packaging, where the antenna is embedded. Thus, it is not contemplated that the antenna will provide significant gain. The RF communication function should, therefore, be designed to be able to close the radio link with no antenna gain. In fact, the RF link analysis may include and provide margin for significant obstruction of the radio signal in its propagation from the parcel to the wireless network receiving antenna. This procedure is well known in the art of radio communication system design.

As in the case of the battery, the choice of antenna material and printing method is determined in accordance with required sturdiness, rigidity, flexibility and other environmental factors. Both conventional circuit board materials and nonconventional materials or substrates and processes, including flexible dielectric and or conductive fabrics, etching of conductive fabrics, deposition of conductive films, glues or paints, and similar methods as will occur to one of ordinary skill will be readily available for realization of the present disclosure.

The sensor subsystem activates the transponder upon the primary recipient event “parcel opened”. The sensor circuit is subject to the same production and mechanization considerations as the antenna circuit, that is, subject to considerations of mechanical and environmental conditions under which the present disclosure is operated and amenable to the same array of variations on printing, deposition and materials employed.

Finally, the transponder needs processing logic comprising sequencing logic and control logic to read and encode events that excite the sensor circuits and cause the encoded message to be formatted and transferred to the radio transmitter subsystem, analog signal processing to condition the signal for presentation to the radio frequency circuit (such as filters and amplifiers), and radio frequency circuitry for translating the digitally prepared information signal to radio frequency (modulation) and radiation by the antenna. All of the methods just described are well known in the art of digital signal transmission by wireless means. In practicing the present disclosure the above system elements may be implemented in a low cost, low form factor (size and weight) and low power consumption manner. There are many techniques available for achieving these goals. One is to utilize significant custom circuitry rather than “off the shelf” components that are designed for other general purpose applications such as microprocessors or self-contained radio transmitters that may be available. A feature of the present disclosure is the use of such custom “single purpose” circuits, but such use is not to be regarded as a limitation in any way. In some embodiments the custom circuitry could be placed on a silicon chip or die. In the art, as is well known, there are technologies for creating and manufacturing such components. Furthermore, these technologies permit “mixed” analog, digital and radio frequency (RF) circuitry to be placed on a common substrate or within a highly integrated miniaturized package. There are available, and may become available, other technologies different from silicon-based (or other semiconductor) chip design and manufacturing processes. These may include processes that print circuits on fabrics by painting or other deposition processes or processes that create circuitry by etching processes. The present disclosure is intended to subsume all of these particular manufacturing and design alternatives and no particular manufacturing or design alternative is intended to be required for or limit the teachings of the present disclosure. It is anticipated that the merits of the present disclosure will motivate many innovations in the field of ultra-miniaturized circuit design and that such process innovations will serve to amplify the utility of the present disclosure.

Sensor Considerations.

A simple arrangement would allow the sensor circuit to support a very small current when the parcel is undisturbed. Upon opening the parcel this current will be interrupted, for example, by breaking a very fine wire. In this embodiment a small battery discharge due to the small sensor circuit current flow prior to occurrence of “parcel opened” may be acceptable. This could potentially limit the lifetime of the battery and may prevent successful completion of the parcel feedback procedure in the event the battery discharges too much. This is addressed in a second arrangement described below. However, the simple, positive current flow arrangement just described can be utilized if such discharge is not excessive. It is a matter of engineering tradeoff between battery size, allowable parcel lifetime in transit after insertion in the mail stream, and allowed parcel idle time at delivery point prior to human action. It is straightforward for one of ordinary skill in the art of electronic circuit design to perform such tradeoffs and design an appropriate circuit.

In the case of the sensor circuit operation just described, in which a small current flows in the sensor loop, a further means of controlling the battery current flow to the rest of the transponder circuit may be provided. This may be accomplished by utilizing an active switching element, such as a transistor.

FIG. 8 shows a typical arrangement of such a control. It is well known in the art how to configure transistors so that the basic operation shown in FIG. 8 is achieved. Certain ancillary circuit elements, such as resistors and possibly capacitors, to optimize the circuit behavior and minimize dissipation may be provided. Again, such circuit details are well known in the art and need not be further described here.

In order to minimize current drawn prior to the “parcel opened” event an alternative approach may be adopted. In the alternative embodiment the sensor subsystem is designed to operate in the following fashion. The first level sensor is again designed to detect and identify the “package opened” event. In one embodiment, the sensor arrangement be such that the transponder circuitry is in a quiescent state, drawing minimal or no power, or, in case of a clock or timer element being included, that the clock be the only energy drawing element prior to the “package open” event. These recommendations are not intended to be limiting, but rather descriptive of some embodiments. Thus, the first level sensor (the first sensor means) should operate by closing a circuit when the parcel is opened. One method for arranging this is shown in FIGS. 7A, 7B.

In FIG. 7A is shown an arrangement of 2 conducting sheets separated by an insulating sheet. The sandwich arrangement is kept under pressure by a spring. The drawstring lead is a strong string, such as fine fishing line, that is connected mechanically to the parts of the packaging that are expected to be torn when the parcel is opened. One can envision multiple configurations in which opening the parcel causes the drawstring to be pulled. One such is shown in FIG. 7C. When the drawstring is pulled the moveable insulating layer slides out from between the conductors allowing contact between them, and thereby allowing battery current to flow. When it is envisioned that multiple possible opening actions exist one may utilize a parallel combination of sensor elements as in FIG. 7B. In FIG. 7B, when any one, or more, of the sensor elements is closed by the action of the drawstring pulling the battery circuit will be closed and battery voltage will be available for use by the transponder circuitry.

FIG. 7A—Mechanical Sensor Element (Sensor element action is “circuit closed upon event”)

FIG. 7B—Sensor Circuitry for Primary Sensor Function (circuit closes upon parcel open event)

FIG. 7C—Configuration of Sensor Drawstring To Close Circuit Upon Parcel Open Event

FIG. 8—Current controlled switch

The system may be operated with a secondary sensor means that detects and identifies additional events, such as the parcel contents being removed from the packaging. In this case the transponder circuit will have been already activated by the “parcel opened” event. Therefore battery current is available for subsequent sensor operations and a simple “circuit break” mechanism may be employed to detect various events, in particular, the “contents removed” event. In order to sense this event it is sufficient to provide a circuit path that is energized by the first sensor circuit upon the “parcel opened” event. This circuit path would naturally be configured so that it is interrupted by removal of the parcel contents. One method for implementing this function is therefore to provide a fine wire that is routed through the contents and which is designed to break upon removal. A second method is to create a circuit path that relies on electrical contact between the enclosing packaging and the enclosed contents. Such contact can be provided via thin conducting film, foil or similar material bonded to the inside of the packaging envelope and, separately, to the contents. When the contents are in the envelope the circuit is closed and current flows. When it is removed, the circuit is broken, which may be detected.

It will be clear to a person of ordinary skill in basic electronics and mechanical design how these two types of sensor mechanisms may be combined to create reliable identification of the true event that befalls the parcel in the recipients hands. In particular, the possibility of confusion caused by various actions may be minimized. For example, the parcel may be torn in half without opening it or removing the contents.

The Sensor Register

Each sensor means is associated with a single bit of information that indicates whether a specific event occurred. In the case of the primary sensor, the current flow in the primary sensor loop (the “package opened” event detector) will induce a voltage across the sensing resistor in FIG. 10. This voltage is input to a comparator circuit that produces a binary output signal. The output signal value is ‘1’ if the sensing resistor voltage is positive (as indicated by the direction of current flow). Otherwise it is ‘0’. The circuit of FIG. 10 can be used with a simple modification to detect events that result in an interruption of current. In this case the logic value at the comparator output is simply inverted, as would be understood by one of ordinary skill in the art of digital electronic circuit design.

Note that, in the case of a configuration in which the transponder wakes up upon “parcel opened” event, only events that occur after “parcel opened” will employ current interruption sensing and utilize the inverted logic just described. This is one battery conservation arrangement. In the alternative, the current flow is active during the parcel lifetime and the sensing of current interruption applies to the “parcel opened” event as well.

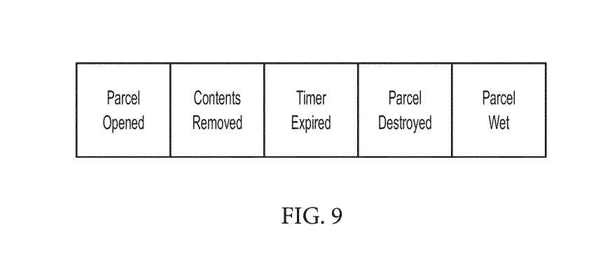

FIG. 9—Exemplary Event Register (One bit each cell, 5 cells)

FIG. 10—Positive current flow sensor detection logic Signal Generator

The signal generator has several components: Feedback Message Payload Builder, Modulator, RF Amplifier, Filter/Impedance Matching, Antenna

Whether or not the Signal Event Encoding is implemented in software or hardware, online (real time, on the fly) or offline (stored for later retrieval), the construction of the Feedback Message is the same. In both cases the state of the Event Register, which in the exemplary FIG. 9 contains 5 bits, is used to point to an appropriate memory location (hardware implementation) or software routine (software implementation). Although there are 5 bit in the example, not all 32 possible states are meaningful. Thus, in this example, which is typical of the application, the maximum number of memory locations or software subroutines is 32. In practice, as will be readily appreciated by one of ordinary skill, the actual number is likely to be much lower.

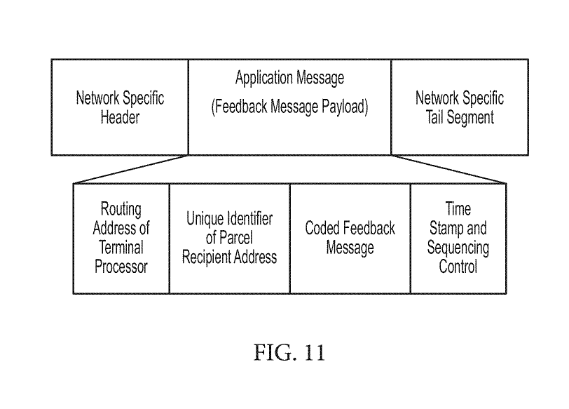

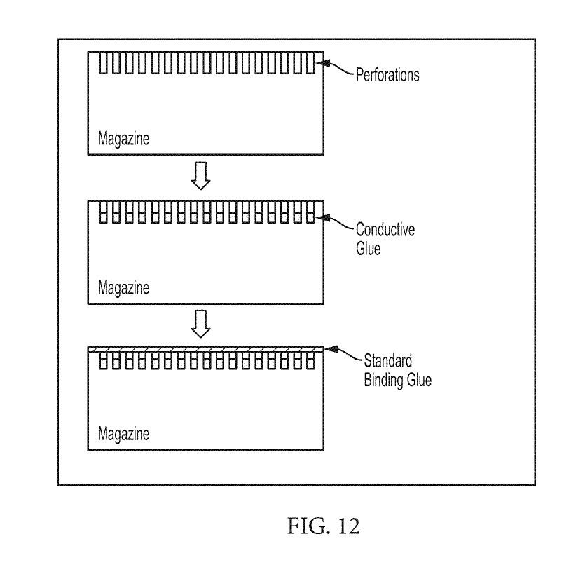

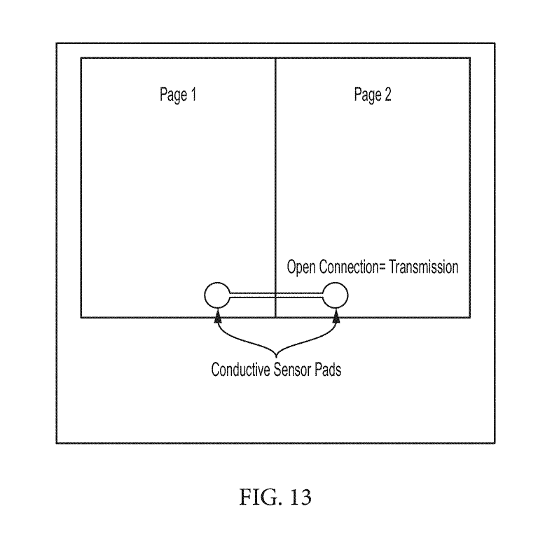

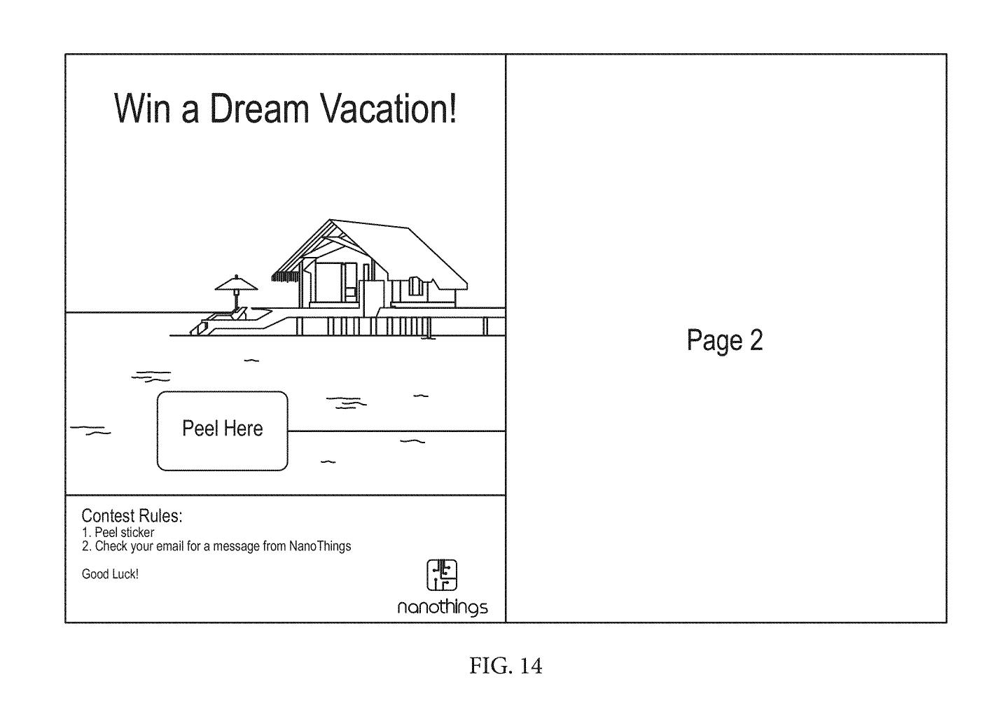

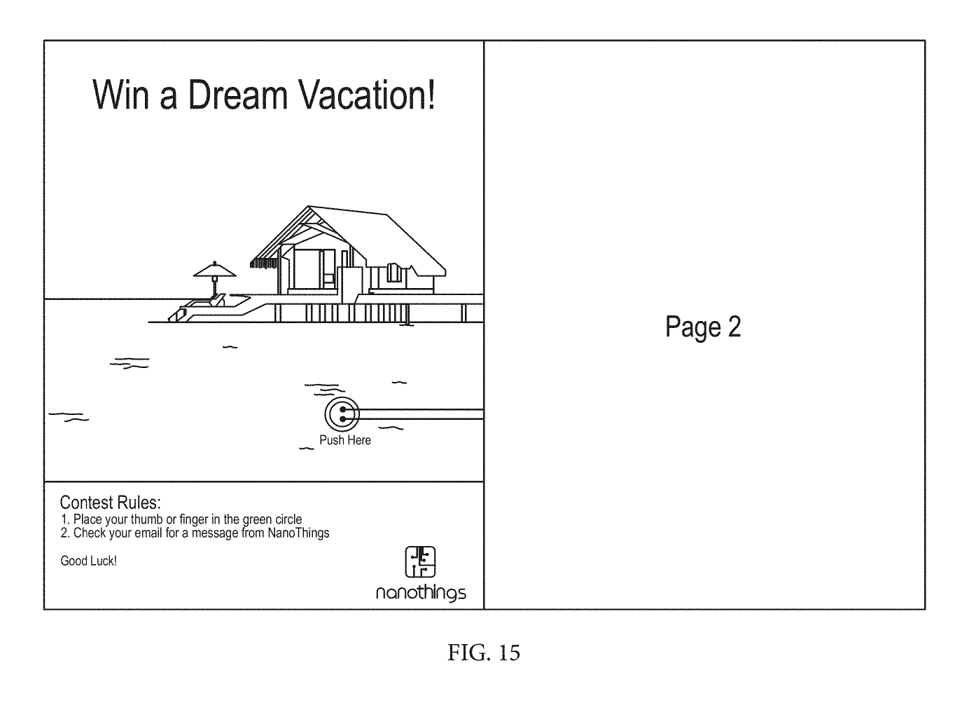

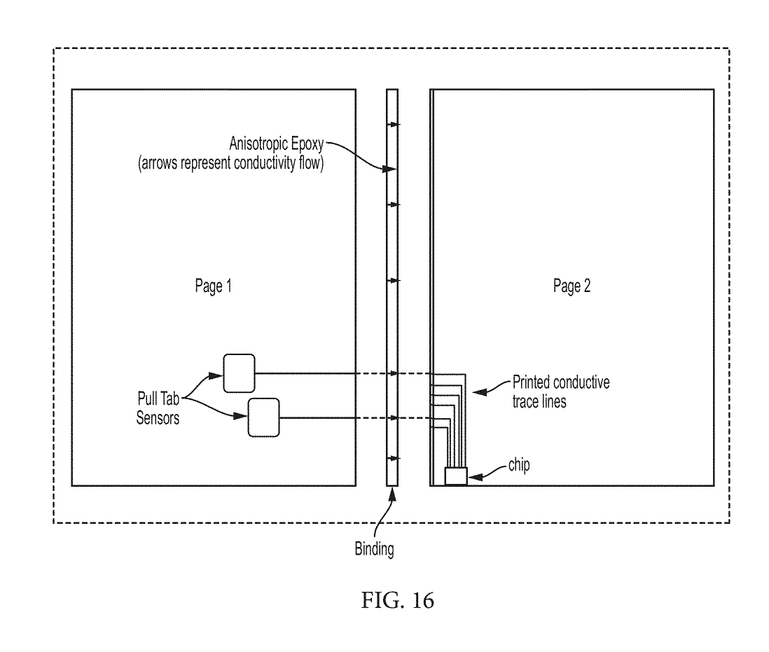

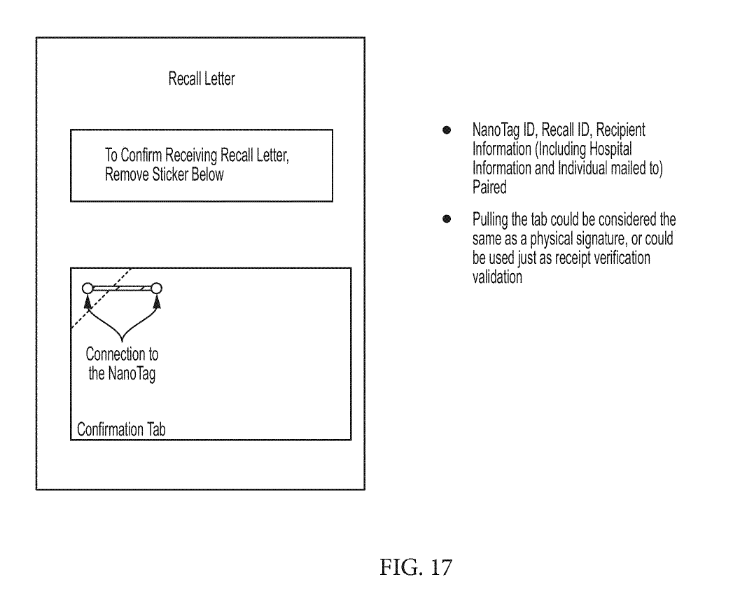

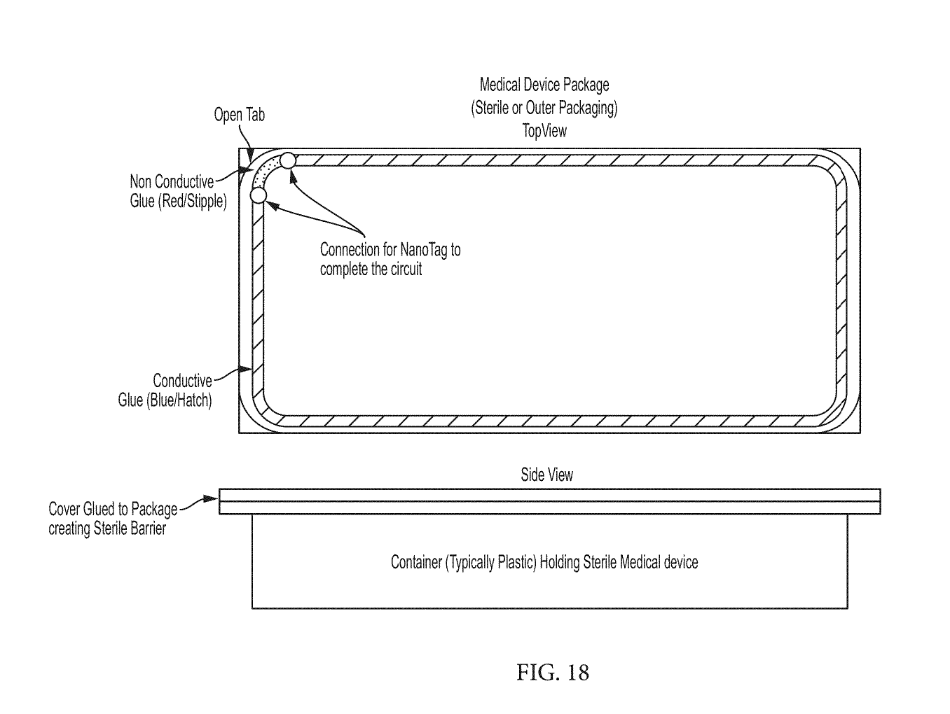

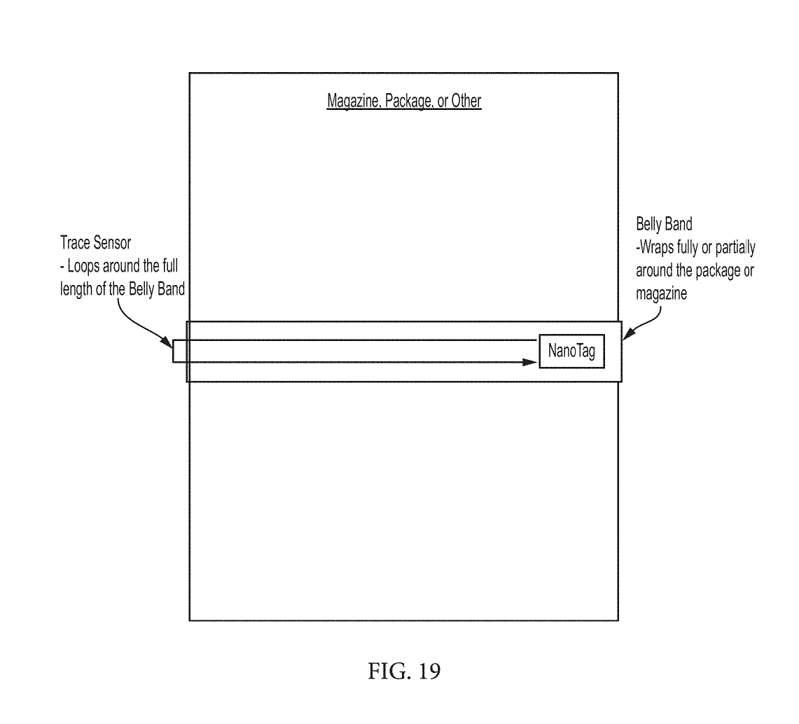

The structure of the Feedback Message Payload, which is embedded in the wireless network datagram, is shown in FIG. 11.

FIG. 11—Wireless Network Datagram Including Feedback Message Payload The wireless network specific elements in FIG. 11 depend, naturally, upon the wireless network the system is operating on. It will be clear to one of ordinary skill in the art how these elements are to be formatted in accordance with the wireless network specification. Certain application specific elements, such as the routing address of the terminal processor, may be already present in the network specific elements. It will be clear one of ordinary skill in the art of computer and or wireless communications how to construct the datagram in a manner compatible with the network.

Another aspect of the message construction pertains to the reliability of the message transmission process. As is well known, there are imperfections in the wireless medium that can result in the datagram not being received or being received with certain errors in the information carrying bits. It is good practice to protect the information by applying error correcting codes to the message bits. Thus, for example, while the exemplary Event Register of FIG. 9 contains only 5 bits, it is prudent to encode these bits into a larger binary sequence prior to transmission. Because the number of bit patterns that are encoded is small (as discussed above, in the example, as well as in most practical applications, this number is less than 32. Thus the simplest method of applying error correcting codes is to pre-encode the valid patterns and store them in memory rather than implement algorithms to encode the data within the transponder processing. While such algorithms are well known in the art, their complexity can be avoided by utilizing the above method. Similarly, other information that needs to be reliably relayed, such as the recipient address, may be encoded as part of the construction of the parcel transponder and need not be processed “on the fly” or in real time in the transponder. It is also clear that the inverse process of decoding need not be discussed in the context of the Intelligent Transponder because the decoding process is performed in the terminal processing computer or another similar resource. Algorithms for decoding and encoding error correcting codes are well known and available. To mention several, one may utilize BCH codes, which includes the simple Hamming code, or Convolutional codes. The effectiveness of the code chosen depends on its complexity, in particular the complexity of the decoding process, which is usually greater than the complexity of the encoding process. Here again, the decoding process is able to be operated in a larger computer and not in real time. This fact implies that very high reliability of the feedback message may be obtained with minimal complexity in the transponder.

The above system elements may be implemented in a low cost, low form factor (size and weight) and low power consumption manner. There are many techniques available for achieving these goals. One is to utilize significant custom circuitry rather than “off the shelf” components that are designed for other general purpose applications such as microprocessors or self-contained radio transmitters that may be available. A feature of the present disclosure is the use of such custom “single purpose” circuits, but such use is not to be regarded as a limitation in any way. In some embodiments the custom circuitry could be placed on a silicon chip or die. In the art, as is well known, there are technologies for creating and manufacturing such components. Furthermore, these technologies permit “mixed” analog, digital and radio frequency (RF) circuitry to be placed on a common substrate or within a highly integrated miniaturized package. There are available, and may become available, other technologies different from silicon-based (or other semiconductor) chip design and manufacturing processes. These may include processes that print circuits on fabrics by painting or other deposition processes or processes that create circuitry by etching processes. The present disclosure is intended to subsume all of these particular manufacturing and design alternatives and no particular manufacturing or design alternative is intended to be required for or limit the teachings of the present disclosure. It is anticipated that the merits of the present disclosure will motivate many innovations in the field of ultra-miniaturized circuit design and that such process innovations will serve to amplify the utility of the present disclosure.

The transponder programming and the packaging processes may be implemented in a variety of ways and orders without affecting the operation of the present disclosure. The wireless network and backhaul means is generic and substitutions may be made without altering the behavior of the present disclosure. Custom networks are also possible.

There are many uses for the present disclosure. The basic operation is well illustrated by describing a marketing or advertising campaign in which the present disclosure is incorporated. To use the present disclosure in this application a marketing campaign would be conducted in which a large segment of the targeted population (defined by geography, demographic data, etc.) receives a piece of marketing material in hard-copy form. Such pieces of material could include flyers, subscription offers, surveys, and other printed material. The delivery mechanism is mail or post or other similar carrier service. The operator of the campaign prepares the media to be delivered to the target recipient and packages/encloses said media in a parcel or envelope containing a transponder in accordance with the present disclosure. The packaging would be prepared by automated equipment that is configured to program the transponder actively or to read the pre-coded transponder passively (as described earlier) and correlate the transponder with the recipient physical address during and simultaneously with the packaging preparation process, including the insertion of the marketing material in the packaging/envelope and the printing of the mailing address on the exterior in the usual fashion. The transponder may be embedded in the packaging material during construction of the latter in a process separate from the media insertion process. The finished parcel including the marketing, etc. material and intelligent transponder is inserted into the mail stream in the conventional manner.

In the above description of a typical use of the present disclosure no limitation is intended and examples are readily identified of variations that include other kinds of media, package contents, and packaging paradigms. The particular application will be sensitive to environmental and physical handling considerations and to the nature of the parcel or package contents (for example, perishable, living, etc.). It will be clear to one of ordinary skill how to adapt the teachings of the present disclosure to applications not explicitly described herein.

A wireless network is selected and appropriate access rights are established in order that the transponder may transmit its signal to the network, have the signal correctly received and demodulated by the wireless network, and the extracted information forwarded to the terminal processor. The manner of formatting the extracted information by the wireless network can vary so that there is no special requirement placed on the wireless network other than forwarding the data in a known format that may be decoded by the terminal processor.

The system then operates autonomously to relay feedback information from the recipient to a pre-designated information processing address, namely the terminal processing address. In the terminal processor the primary feedback information is extracted and various secondary statistical information may be generated.

The present disclosure usage can be extended to other areas such as delivery services. One such application is perishable item delivery, such as food or medicine. The present disclosure can also be generalized to provide detailed tracking capabilities to parcels rather than merely delivery event reports. In addition, tracking of items other than mail items can be considered, including animals, people, automobiles, and even personal items such as purses, wallets, etc.

The present disclosure can be augmented straightforwardly to permit other affirmative consumer actions to be handled using the same technology. Examples of such are transaction processing via “peel/click here to learn more”, “peel/click here to buy” processing. Such capabilities are an immediately evident extension of the capabilities enabled by the present disclosure that one of ordinary skill will recognize as variations on the basic theme of sensor based event detection. One difference is that the primary application described is passive and does not require the recipient to take any action beyond the action recipient would ordinarily take. The possibility of accepting “active” stimuli rather than only passive, such as by providing an electrically enabled “peel here” label or similar means, is merely a variation on the behavioral parameters under which the present disclosure is operated. Such behavioral parameters' variability and range are not to be construed as limiting the present disclosure's field of use or teachings in any way.

The present disclosure streamlines and economizes the mass mail industry in a manner that will save energy and natural resources. In addition, the interest level within the consumer market may be expected to increase as the feedback processes enabled by the present disclosure improve information flow and optimize matching of media to recipients.

Other expansions of the present disclosure include the inclusion of fingerprint reading and identification technology and GPS (Global Positioning System) technology.

These represent additional capabilities that, when integrated with the primary capability of the present disclosure described herein, can provide added security, authentication and tracking capabilities and associated value.

In one embodiment, a low-cost, versatile, printed tracking device and systems and methods for using the printed tracking device in a low power wide area network (“LPWAN”).

Asset management throughout the world is a multi-billion dollar industry rife with inefficiencies. We define asset management as the tracking of an item as it travels from one place to another. The asset could be a package, a product, a container, a pallet, timber, a piano, a case of wine, blood or other health-related materials, a letter, a magazine, a vehicle, a pet, a human, an electronic device, frozen food, perishable items, and so forth. In short, an asset is anything to which a tracking device could be attached. Accordingly, the asset tracking industry has an unlimited number of use cases.

In the past, asset tracking has varied widely from industry to industry. Generally speaking, the more valuable the asset, the more sophisticated the tracking mechanism has been. On the low-cost asset management end of the spectrum, individuals seeking to track mass mailed media for marketing purposes, for example flyers and brochures, have used very primitive metrics to determine conversion rates of the advertisements sent via traditional mailings.

In the United States the media mail-based marketing and advertising business is a (USD) 46 billion dollar industry. The size of the global industry is at least 10 times that figure. For over a century this industry has operated in a manner that provides only the most primitive feedback relating to the effectiveness of a given mass mailing campaign, namely, whether or not the person converted, the definition of which varies from advertiser to advertiser, and only in such events, will mailing campaign operator will receive positive notification of said recipient's interest in, and response to, the material. However, in the vast majority of cases, the media or parcel is discarded unopened, opened and then discarded, destroyed by the recipient (e.g., shredded) or allowed to remain in any one of a number of states of oblivion.

For more valuable assets, such as cargo that may be transported via truck, train, ship, or airplane, it is well known in the art to use tracking mechanisms such as GPS to track a shipment, whether it is on a truck, train, ship or plane. For these use cases, GPS provides an excellent means of tracking location. It suffers however from some drawbacks. First, most GPS location data are transmitted via cellular networks, which are expensive and power hungry platforms upon which to operate. Although GPS data can be sent via Wi-Fi networks, the short range of these networks is a limiting factor. In addition, GPS tracking does not provide additional information such as temperature, pressure, light exposure, humidity, and so forth for each individual item within a shipment.

Irrespective of the asset to be tracked, design considerations for any asset tracking device include: (1) the cost of hardware production; (2) power consumption; (3) form factor limitations; (4) disposability; and (5) network connectivity cost. In terms of network choices, cellular networks are ubiquitous and have the advantage of providing long range coverage.

The downside, however, of cellular networks is the high cost of network access and the power consumption of devices deployed on the cellular network. Wi-Fi and Bluetooth networks are less expensive to deploy, but have limited range. RFID networks, e.g., those in the 125 KHz, 135 KHz, or 13.56 MHz range, have the advantage of providing free access, but also suffer from the very limited tracking range they provide.

There is this a need for a low-cost, versatile tracking device that can provide accurate analytics, including without limitation, location, environmental, and behavioral data, about a movable article or its recipients to individuals or machines seeking information related to at least one of a panoply of metrics that could be reported about the moveable article.

In one embodiment, a tracking device for use in an LPWAN network, a system for using the tracking device, and a method of using the tracking device is provided. In one embodiment, a small form factor, low power consumption requirements, and long range transmission capabilities. In an embodiment, we describe a tracking device wherein the majority of the electronics are printed on a single substrate. A substrate could be any suitably sturdy electrically compatible medium, including without limitation, cardboard, Mylar film, plastic, circuit board, or composites of these or similar materials.

In one variant of this embodiment, only a sensor could be located off-substrate. The printing aspect of the present disclosure includes the use of either conductive ink or metal deposition or a hybrid arrangement according to the conductivity required in a given portion of the circuit.

There are several ways to produce the circuitry with components as functional modules. In one embodiment, we use a classical printed circuit board (“PCB”) made of an epoxy with copper layer, having a protection layer on the copper, whereby a portion of the protection layer is removed. In this embodiment, we include etching in the free copper area. We also strip off the rest of the protection layer from the remaining copper traces. We further include stencil printing of solder paste to the copper traces. The components are “pick & place” and are secured to the PCB via a heating process in a reflow oven for soldering.

In an alternate embodiment, the circuitry could be produced by using a rigid epoxy-copper PCB a thin and flexible Polyimide film with a copper layer in place of the PCB.

In an alternate embodiment, the circuit could be printed via a printing process for conductive traces (e.g. silver traces) to a film (e.g. Polyethylene terephthalate, Polyethylene naphthalate, and the like)) using stencil printing of solder paste. In this embodiment, it would be advisable to use low temperature solder paste because these polymer films cannot stand the high solder temperatures of normal soldering. This embodiment could also place components via “pick & place,” followed by heating up for soldering.

In an additional embodiment, the circuit could be printed via a printing process for conductive traces (e.g. silver traces) to a film (e.g. Polyethylene terephthalate, Polyethylene naphthalate, and the like) and stencil printing or normal printing of a glue or binder, which conductively glues the components to the silver traces. In this embodiment, the circuit could be cured at room temperature or heated up for faster curing.

The printing methods for printing the circuits can vary in alternate embodiments. In one embodiment, one could use a screen printing method or process, which has the advantage of providing relatively thick conductive layers with sufficient resolution. In an alternate embodiment, one could use a gravure printing process, which has the advantage of having a lower thickness than screen printing, while still having good resolution.

In an alternate embodiment, the circuit could be printed with a flexographic printing method, which provides thickness similar to gravure and sufficient resolution.

In alternate embodiments, in order to increase thickness, any of the above printing methods could be combined with printing seed layers having electroplating or electro-less platting thereon.

In these methods, diverse curing methods, such as convection heating, infra-red, ultraviolet, ultrasonic, and photonic, could be used. These curing methods are also useful if sintered nanoparticles are used.

Many different materials can be used to print conductive traces, including without limitation: carbon (including graphene), silver, copper, silver plated copper, organic conductive polymers, tin, and inorganic materials like indium tin oxide.

In one embodiment, we disclose a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit. For purposes of clarity, we intend the term “LPWAN” to mean a network operating in one or more ISM bands of any given country.

In an alternate embodiment, the transmitter could be replaced by a transceiver or it could be coupled to a receiver.

In an alternate embodiment, the substrate comprises a thin film, a cardboard member, a plastic member, a paper member, a composite wood member, or a circuit board.

In yet an additional embodiment, the circuit and the antenna are coplanar. In some additional embodiments, there could be multiple antennas, either co-planar or not. These embodiments could include antenna switching means and optionally a ground plane.

Antennas in any of these embodiments could be single band, dual band, broadband, directional, omni-directional, high gain, low gain, and any combination thereof.

In another embodiment, the processor is a small state machine or a micro-coded bit slice processor.

In a further embodiment, the tracking device further comprises a clock.

In an alternate embodiment, the sensor is configured to monitor at least one data metric the data metric comprising one or more of: a temperature, a measurement of relative humidity, a traveling velocity, an acceleration, a measure of light, a shock, a pressure, a vibration, a location, a gas, a fire, an orientation in space, a g-force, a sound, a stacking height, a weight, state of integrity, for example if a package has been opened.

In an additional embodiment, the processor is configured to create an event code based on input received from the sensor.

In yet another embodiment, the transmitter is configured to transmit an event code. In an alternate embodiment, wherein we further include a receiver, the receiver could be configured to receive an event code.

In a further embodiment, the tracking device further comprises a power source wherein the power source comprises one or more of a battery, a capacitor, a super capacitor, a solar power collector, or a wireless power device capable of harvesting energy form an ambient field.

In an additional embodiment, the power source is a printed battery, a printed capacitor, a super capacitor, or any combination thereof.

In yet another embodiment, the LPWAN network is a SIGFOX network, a long range radio “LoRa” network, a Weightless network, a Greenwaves network, an LTE-MTC network, a Haystack network, an Ingenu Random Phase Multiple Access, or a Narrow-Band Internet of Things (“N-B IoT”) network.

In a further embodiment, there is a tracking device for use in a low power wide area network (LPWAN) comprising: a circuit on a substrate, the circuit further comprising a finite state machine, a transmitter, and a power coupler configured to receive power from an external source; a printed antenna on the substrate communicatively coupled to the circuit; and a sensor communicatively coupled to the circuit.

We additionally disclose a tracking system for tracking at least one data metric of an item comprising a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit; a low power wide area network configured to receive and transmit the data metric; and a computer processor configured to receive and analyze the data metric. In this and other embodiments herein the substrate can be printed or etched on polymer film.

We further disclose a method of tracking an item using a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit comprising the steps of: receiving from the tracking device a data metric measured by the sensor; and analyzing the data metric in order to determine a tracking state.

The present disclosure provides a novel, low cost, real time, information feedback device, system and method that can be used in myriad asset tracking scenarios. Some exemplary use cases are provided with the caveat that these embodiments are intended to be a subset of the wide array of use cases in which the inventive device, system and methods could be used.

Mass Mailing Marketing Use Case. Embodiments disclosed herein can be used to automatically report a mail recipient's actions and reactions to a marketing campaign operator. In particular, the present disclosure describes and teaches a business method for determining, at a minimum, if a marketing parcel has been opened, and if the contents have been read. This behavioral information is valuable because it can be used to measure the effectiveness of mass mailing as a marketing tool. It will be clear to those familiar with marketing analytics that there are additional types of information that may be provided in the feedback message, including time stamps of events, for example, without limitation, delivery, opening, etc.

The present disclosure also provides a means for implementing methods using a device capable of accessing public or private wireless networks and of transmitting feedback information from the recipient's location to the campaign operator's endpoint data processing location. In some embodiments, we disclose a device coupled to sensors, which could be embedded within a parcel or other mailed item. In these embodiments, valuable data regarding consumer behavior can be aggregated and stored in cloud computing devices, on servers, and the like. In this use case, users can access new data-analytics methodologies, which have the capability of streamlining marketing and advertising campaigns and expenses while preserving natural resources by eliminating waste. In this way, users can retarget and continuously optimize the parameters of advertising campaigns based on valuable behavioral feedback including package open rates, demographic, geographic and physical data about the parcel's fate.

In addition to mailings as described above, the use of device embodiments in a magazine or similar encapsulation provides an effective and highly efficient method for “closing the loop” on advertising content delivery through advertisements in magazines. By incorporating sensors within an advertisement, or multi-sensors within a plurality of advertisements, advertisers may obtain crucial consumer feedback. The types of feedback and the activation of the feedback by various stimuli, e.g., scratch off, peel off, pressure sensor or other tactile input mechanism, is limited only by the imagination.

In this type of application, the need for microminiaturization is lessened due to the form factor and weight of the carrying media, e.g., magazines. The embodiments described herein may be readily partitioning into a small number of sub-modules so that the configuration of the technology may be optimized to the application and the most efficient deployment may be realized.

In an alternate use case, embodiments herein could be utilized as so-called “belly bands.” One version of a belly band could be a thin strip of paper wrapped around the exterior of a magazine. In this configuration, device embodiments could be added to pre-produced media such as magazine as well as to other packaging that can accept a wrapper. The sensors within the device can detect various actions, which we refer to as a “state of integrity,” such as removal or opening of the exterior wrapper

Parcel Tracking Use Case. Parcel tracking can be implemented directly by including tracking device embodiments in the packaging of the parcel. Parcel tracking can be used to monitor the progress of the parcel through delivery channels. In addition, by configuring the tracking tag with appropriate sensors, the conditions to which the parcel are subjected during transit may be monitored and reported. Exemplary conditions, without limitation, include, travel velocity, location, temperature, humidity, air pressure, g-force, vibration, sound, light, smoke, fire, harmful gas, loss of air pressure, loss of oxygen, and the like.

Primary Asset Tracking. Primary assets may be tracked in a manner similar to the tracking of parcels using embodiments disclosed herein. Certain secondary assets are used in the warehousing and shipping of primary assets. An example of a secondary asset is a pallet. Pallets are used in transport and warehousing operations in which primary assets are loaded on pallets for movement or storage. Pallets are intended to be reusable. A problem that arises in the flow of pallets through a logistics process or channel is, they are often lost or discarded when the primary assets are unloaded. Embodiments disclosed herein can overcome this problem by being integrated within a pallet. In alternate embodiments, the device could be coupled to larger battery sources, renewable power sources, energy harvesting sources and the like to increase the transmit/receive power of device embodiments.

In this use case, it may be desirable to monitor a variety of environmental conditions including, but not limited to, temperature, humidity, exposure to liquid or fire or smoke, velocity of travel, orientation of the item, e.g. “This End Up,” stacking height of items, weight, location, and the like. The type of item metrics would likely vary depending upon the nature of the item. For example, the owner of a piece of fine art who employs embodiments disclosed herein may want to monitor exposure to any environmental elements, humidity, temperature, location, stacking height, orientation, and location. In contrast, an individual shipping a book may just wish to monitor location. The data available in this use case is limited only by the types of sensors available to measure environmental conditions.

Different embodiments can be tailored to accommodate a user's desired metrics.

Medical Field Use Case. In the medical field, embodiments can be used to track ambient conditions of medical materials such as tissue, organs, blood, urine, biopsies, cryogenically frozen materials, humans, cadavers, and the like. In this use case, the vitality of such items depends critically on the timeliness of delivery as well as the preservation of controlled environment. Use of the present disclosure provides a method for monitoring and guaranteeing these variables.

Autonomous Inventory Tracking Use Case. In this alternate case, the disclosed devices can be used to autonomously track inventory and to automatically order additional supplies when inventory begins to run low.

Compliance Tracking Use Case. In an alternate use case, the disclosed devices, systems and methods could be used to ensure compliance with recall protocols such as may be instituted by the Food and Drug Administration and similar administrative bodies. The disclosed embodiments would provide verifiable compliance checking, which would enhance and streamline recall compliance. The disclosed devices can be embedded into recall letters. When the letter is opened, an event code can be transmitted back to a main server or other computing device. The event code would provide verification of receipt of the recall notice, which would be helpful compliance data for the recalling company or entity to obtain.

Specifically, the event code can act as verification of receipt of the recall notice.

The present disclosure allows users to embed device embodiments in media parcels, or other packages, containers or transportable items as described above, which can automatically sense opening of a parcel, opening of the enclosed material and other recipient actions, as well as a multitude of environmental variables. The sensed actions or environmental variables are encoded into a digital feedback message (“event message”) optionally including timestamps. In some embodiments, the digital feedback messages are correlated to identifying information stored in a database paired so as to pairing of the reported action with an entity's physical address or identity.

In embodiments, these digital feedback messages can be optimally tailored to include the minimum necessary information to accomplish the user's tracking goals. In this way, a user can lower bandwidth costs, thereby reducing power transmission requirements and redundancy protocols. In embodiments, it may be desirable to create a communication pathway between a tracked item, irrespective of its use case, and a logistics management client that can track item metrics for either real-time analysis or for historic predictive data purposes.

Some advantages of embodiments disclosed herein include automation in that the system is entirely automatic and requires no manual scanning by third party carriers. The system takes advantage of the emergent Internet of Things (IoT) paradigm. By exploiting IoT platforms, especially certain wireless transport networks that are currently in development and deployment worldwide, e.g., SigFox and Long Range Radio “LoRa” network, the benefits of the present disclosure may be realized without the need for creating, developing and deploying extensive infrastructure. The present disclosure works in conjunction with infrastructure that is already available. This infrastructure differs from the cellular infrastructure in that it is optimized for low power, low data rate operation. Cellular and related infrastructure is comparatively expensive to deploy and operate and is not efficient for relaying large volumes of small disjointed data packets from widely distributed sources, such as those used in digital feedback messages of the present embodiments. The biggest differences between cellular and LPWAN networks is, cellular networks operate over licensed frequency bands, which are expensive to purchase/license. LPWAN frequency bands, in contrast, are unlicensed, and therefore free for anyone to use.

Indeed, in some use cases for embodiments disclosed herein, a transmitter within the device may be required to send very short transmissions, e.g., lasting a few tenths of a second. In the mass mailing use case, the transmitter may only need to send a single transmission in order to report the actions taken by the recipient of the mass mailing. This model is in contrast to infrastructure and devices designed to carry large volumes of data from recurring usage instances, e.g., cell phone calls, video streaming, etc.

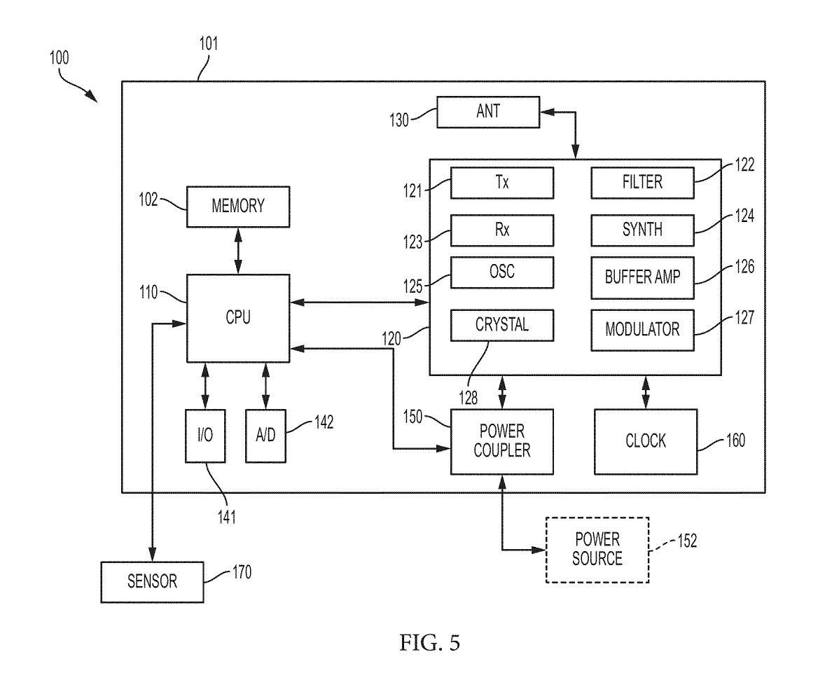

Turning to specific embodiments, FIG. 5 depicts a block diagram of a tracking device 100 that can be used in any or all of the use cases described above as well as other use cases that would be obvious to those of skill in the art. In an embodiment, the tracking device 100 is designed to be used in a low power wide area network (“LPWAN”), which is an open standard frequency band located at about 900 MHz in the United States and 868 MHz in Europe. These bands are intended to be exemplary and not limiting. ISM bands vary from nation to nation. The embodiments disclosed herein are intended to operate on any ISM band in any country. Similarly, the physical structure of what we disclose could operate on bands outside of ISM bands. But the advantageous cost savings may be lost.

LPWAN is advantageous for embodiments of the present disclosure because the tracking devices 100 can operate on low power while simultaneously having long range transmission capabilities. The tracking devices 100 disclosed herein are suitable for use in LPWAN because the tracking data transmissions, or event codes, are relatively small. In some embodiments, tracking devices 100 send less than 1000 bytes of data per day at 5000 bits per second or less.

The tracking device 100 is comprised of a circuit 101 coupled to a sensor 170. The circuit is on a substrate 101, wherein the substrate could be a thin film, a cardboard member, a plastic member, a paper member, or a composite wood member. In this and other embodiments, the circuit could be printed, etched or created via other methods well known in the art to create a conductive structure The circuit 101 can in embodiments contain any form of printed circuit board, which is comprised of copper plating, masking, and etching. In embodiments, the substrate 101 is designed to be flexible and thin so that it can be securely attached to items such as magazines, marketing mailings, assets, medical supplies, and similar items as described in the various use cases and as obvious to those of skill in the art.

The circuit can be comprised of memory 102, a processor 110, a transmitter 120, which can be a transceiver in some embodiments, a power coupler 150, and an antenna 130. In some embodiments, the memory 102, which could be a RAM, a flash memory, or any other memory known to those of skill in the art, is communicatively coupled to the processor 110. The processor 110 is communicatively coupled to the transmitter/transceiver 120 and a power coupler 150. The transmitter/transceiver 120, which is also communicatively coupled to the power coupler 150, can be further comprised of one or more of the following: a transmit block 121 a receive block 123, a filter 122, a synthesizer 124, an oscillator 125, a buffer/amplifier 126, a modulator 127, a crystal 128 and a power source 152.

The power source 152 can be a printable element such as carbon-zinc, zinc magnesium dioxide, batteries, or power sources known to those of skill in the art. Printing can be arranged so that the printing substrate 101 is compatible with the handling of a parcel or item containing the tracking device 100. Thus, printing on semi rigid substrates 101 such as circuit boards may be appropriate when rigid packaging and tracking device 100 construction is used. In other embodiments, the printing may be applied to fabrics that are flexible, such as Mylar.

The antenna 130 could be a loop or dipole formed from a length of conductive material or dielectric material. The shape, thickness, and composition of the antenna 130 will determine its radiation behavior, including the directivity and gain. It is advisable that the antenna 130 be non-directional so that transmission to a base station does not depend on the particular position or orientation of the parcel or its packaging, where the antenna 130 is embedded.

In some embodiments, it may be desirable to utilize physically small antenna 130 geometry in which antenna 130 features, including overall length or area, are smaller than the operating radio frequency wavelength. In these embodiments, the substrate 101 could be configured to provide a ground plane with respect to which the antenna 130 operates. The use of ground planes in antenna design is well known in the art. In the present disclosure, one point of novelty is the manner in which the overall tracking device 100 is integrated as a package. The ground plane can become an integral part of the substrate's 101 mechanical design as well as its electrical design. In some embodiments, the addition of a ground plane may be achieved by creating a “sandwich” structure in which the ground plane is inserted between two outer substrates 101. In this embodiment, the ground plane may be shared by antennas 130 printed separately on the two sides of the sandwich. This has the advantage of allowing smaller antenna 130 features while simultaneously providing antenna diversity, a benefit well understood in the art of communication system engineering.

In some embodiments, the antenna 130 will provide minimal or zero gain. In these embodiments, the RF communication function could be designed close the radio link with no antenna 130 gain. In fact, the RF link analysis includes and provides margin for significant obstruction of the radio signal in its propagation from the parcel to the wireless network receiving antenna. This procedure is well known in the art of radio communication system design.

As in the case of the power source 152, the choice of antenna 130 material and printing method may be determined in accordance with required sturdiness, rigidity, flexibility and other environmental factors. Both conventional circuit board materials and nonconventional materials or substrates and processes, including flexible dielectric and or conductive fabrics, etching of conductive fabrics or layers, deposition of conductive films, glues or paints, inks, and similar methods as will occur to one of ordinary skill will be readily available for realization of the present disclosure.

In some embodiments disclosed herein, the antenna is on the same substrate 101 as the transceiver 120, the processor 110, memory 102, or alternatively finite state machine in lieu of a processor 110 and memory 101, and power coupler 150.

In additional embodiments, the substrate 101 can also include input/output devices 141, an A/D and/or a D/A convertor 142, or a clock 160. The clock 160 could be used to measure a timeout event, or as an alarm or timer. In alternate embodiments, there could also be an RFID element, RF element, Wi-Fi element, Bluetooth element, cellular element, and the like coupled to or added onto the substrate 101.

The tracking device 100 also includes at least one sensor 170 coupled to the substrate 101. The sensor(s) 170 can be chosen to measure myriad events or conditions such as the opening of a package, breaking a seal, movement, temperature variation, acceleration, vibration, humidity, pressure, g-force, smoke detection, fire detection, gas detection, light, sound, orientation, stacking height, weight, and the like. For example, in the use case of mail marketing, a sensor 170 could be embedded in a parcel.

In one embodiment, the above system elements are implemented in a low cost, low form factor and low power consumption manner. There are many techniques available for achieving these goals. One is to utilize significant custom circuitry rather than “off the shelf” components that are designed for other general purpose applications such as microprocessors or self-contained radio transmitters that may be available. In some embodiments, the tracking device 100 can be a custom-made, single purpose device. In embodiments, the custom circuitry could be placed on a silicon chip or die.

In the art, as is well known, there are technologies for creating and manufacturing such components. Furthermore, these technologies permit “mixed” analog, digital and radio frequency (RF) circuitry to be placed on a common substrate 101 or within a highly integrated miniaturized package. There are available, and may become available, other technologies different from silicon-based (or other semiconductor) chip design and manufacturing processes. These may include processes that print circuits on fabrics by painting or other deposition processes or processes that create circuitry by etching processes. The present disclosure is intended to subsume all of these particular manufacturing and design alternatives and no particular manufacturing or design alternative is intended to be required for or limit the teachings of the present disclosure. It is anticipated that the merits of the present disclosure will motivate many innovations in the field of ultra-miniaturized circuit design and that such process innovations will serve to amplify the utility of the present disclosure. Sensor considerations.

In one use case, the sensor 170 could be a conduction path consisting of fine wire or printed conducting material. The sensor 170 could be configured to open or close a circuit when the parcel is opened, that is, when the external packaging is opened to access the contents within. In alternate embodiments, additional sensors 170, which could detect the removal of package contents, could be included in the tracking device 100.

Upon detection of the “parcel opened” event, which alternatively could be called a state of integrity, a current flow or interruption may create a voltage across a sensing resistor, which in turn could awaken digital processing circuitry in the processor 110. When the processor 110 is activated by the “parcel opened” event, the binary code produced by the sensor 170 could be used to construct a pointer, which instructs the processor 110 about assembling a message, called an event code. This instruction can be processed either as a program jump in a software implementation or as a pointer (address) to a memory 102 location from which the event code is retrieved. The latter method has the benefit of using low cost memory 102 circuits rather than requiring a processor 110 to build the event code “on the fly” from primitive instructions.

The processor 110 can be thought of as a special purpose computer. In implementation, it may consist of a software controlled microcomputer that executes a stored program. In alternate embodiments, the processor 110 could be a small state machine or micro-coded bit slice processor. The latter will execute the same sequence of control operations as a software controlled microcomputer, but with the added advantage of being lower cost both in terms of manufacturing cost and power consumption cost.

The processor 110 is configured to receive input information from the sensors 170. Upon receipt of sensor 170 input, the processor 110 can generate an event code. The event code is a binary sequence that identifies an event. In many embodiments, the event code may be limited to having only a few bits of information therein. In alternate embodiments, event codes could be further expanded by means of well-known error correcting coding methods. One such coding method, which is exceptionally simple, is simply repeating the information bits a number of times. For example, if each bit is replicated 3 times, it is possible to detect a single bit error by simply majority logic. More powerful error correcting codes are also well known, such as BCH codes, and would be natural candidates for use in the present disclosure.

If the event codes are pre-stored in memory, the use of more complicated codes than the repetition code just described is straight forward. In either case, it will be clear to one of ordinary skill in the art that the use of event codes will enhance the performance of the system and that there are many coding schemes available in the literature from which to choose.

In an alternate embodiment, I/O devices 141 can be coupled to the processor 110. In these embodiments, the I/O devices 141 can be configured to detect additional events that may be coded as additional event codes.

In different embodiments, the tracking device 100 can have varying form factors including but not limited to differentiations in size, weight and power requirements. In some embodiments, the tracking device 100 may be provided in semi-knock-down form, in which case the components of the present disclosure could be separated into major blocks, such as the RF electronics module 120, a battery/power source 152, an antenna 130, and at least one sensor 170. These blocks may be adjusted to accommodate various applications consistent with the present disclosure. For example, the power source 152 for some applications, like pallet or container tracking, may be made larger so that the usable active life of the transceiver 120 matches the pallet/container lifetime or in-service time interval. In other scenarios, such as direct mail, the power source 152 may be made very small because the tracking device 100 would only have to perform a small number of data transmissions.

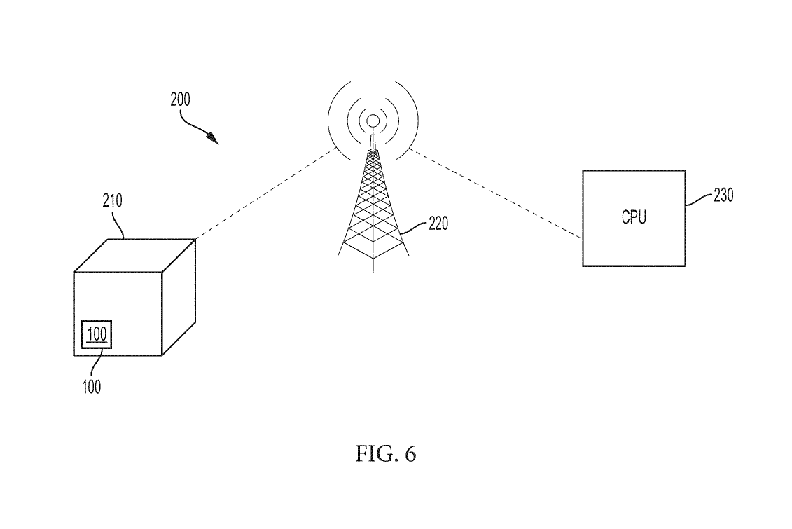

FIG. 6 shows a tracking network 200 according to the present disclosure. In this tracking network 200 there is a tracking device 100 affixed to an item 210, a low power wide area network 220, and a central processing unit 230, which serves as a logistics management client. The tracking network 200 is capable of receiving, demodulating and decoding a radio signal emitted from the tracking device 100, extracting the information carried by the signal, e.g., one or more event codes, and transferring the decoded payload via a digital network interface to a digital carrier network, such as the Internet or other digital network capable of routing digital information (such as data packets), which is further configured to forward the feedback message payload to a logistics management client 230. In some embodiments, the operators of the logistics management client 230 could use analytics sent from the tracking device 100 for myriad purposes such as determining location, temperature, humidity, user actions taken such as opening a package, and the like as previously described with reference to the tracking device 100. The logistics management client 230 can include some type of memory storage so that events associated with tracking device 100 can be stored and used in the future.

The logistics management client 230 can employ an application interface (API) that is specific to the wireless network in order to perform the information retrieval from the tracking network 200. This API could also be a conduit for data access stored in internal servers related to event codes and behaviors captured by the tracking network 200. In particular, if the tracking network 200 does not provide delivery of the feedback message to the logistics management client 230 via standard network routing techniques, e.g., an Internet using IP addresses, but rather stores the recipients' feedback datagram or datagram contents in a storage buffer, a method (utility or API) could be used to retrieve the contents from a storage location within the logistics management client 230.

In one exemplary use case, the tracking network 200 could be used to determine the outcome of a mailed marketing campaign. In this use case, once the parcel events, meaning the events that occur with respect to the parcel 210 at an individual mail recipient's home, have been deemed to have run their course, the next step could be transmitting an event code from the tracking device 100 to the network 220. The event codes could reflect parcel events such as whether or not the parcel 210 was opened. If the parcel was never opened, in some embodiments, there may be no signal sent over the tracking network 200. In other embodiments, a system timeout could be employed whereby an event code is transmitted after expiration of the timeout period indicating that the mail recipient never opened the parcel 210, which presumably means it was discarded.

In this embodiment, the event code could be formatted to include a field of binary information containing an event code payload. The event code payload could contain a unique address code for the parcel 210, or an encoded equivalent thereof, a message element identifying what happened to the parcel 210, and an address of the central processing unit 230, or logistics management client. In these embodiments, it may be desirable to correlate the tracking device 100 with a parcel 210 recipient.

The radio signal transmitted in the tracking network 200 can include a short header and or preamble field that may be used by the wireless network for synchronization and identification purposes. An additional non-information bearing stabilization preamble may also be provided so that the radio frequency circuits have time to stabilize before the information bearing portion of the radio signal, i.e., header, preamble, and payload, is passed through the circuit.

Once the composite binary signal is prepared, the modulation process may be applied to it to create a radio frequency signal. The modulation process is specific to the radio network employed. There are numerous modulation processes to choose from. The one that is described here is typical. Any other modulation process can be supported and would be effective in realizing the present disclosure so long as it is compatible with the wireless transport network the system is operating on. It is well known in the art how to create modulated digital communication signals and one of ordinary skill in the art can readily adapt the teachings herein to accommodate any of them.

Some examples, without limitation, of suitable wireless networks are SIGFOX, long range radio “LoRA”, Weightless, Greenwave, LTE-MTC, Haystack, Ingenu Random Phase Multiple Access, or Narrow-Band Internet of Things (“N-B IoT”).

In some network embodiments, it may be advantageous to use multiple transmissions to ensure the event codes are correctly processed. In this embodiment, the processor 110 within the tracking device 100 could be programmed to stagger the repetitions of the radio signal transmission so as to minimize burst traffic overloads on the wireless network 220. In alternate embodiments, burst traffic should not be an issue because the traffic generated by the system is of very low volume, which means the wireless network 220 can accommodate a burst of continuously repeating transmissions that lasts a fraction of a second.

The Pairing Process is the process of associating an individual tracking device 100 with a recipient or asset owner. In some embodiments, the tracking device 100 includes a means for programming information that is specific to the intended recipient, which may be a postal address or other unique recipient identifier. Recipient identification data is made available to the logistics management client 230, which, in turn, can translate event codes into information legible and useful to end users. This programming of the tracking device 100 for this use case, can be implemented at the manufacturing stage. For example, the tracking device 100 could be loaded during manufacturing with a generic but unique identifying code that will be transmitted as part of a modulated signal. During manufacture, and after the point in time when recipient-specific data for a particular tracking device 100 becomes known, the tracking device's 100 unique identifying code may be stored in a database together with the associated recipient-specific data, for later use by the logistics management client 230. In this scenario, the tracking device's 100 unique identifying code may be accessed via optical scanning or electrical interface, or other means convenient and suitable within a mass production environment.

Alternatively, the programming means may be arranged in a manner that allows the tracking device 100 to receive digital information wirelessly by being placed in the field of a programming instrument. Still another method of programming, which utilizes a reverse process, is to provide the tracking device 100 with a passive identification emission means, similar to RFID, in which the tracking device 100 emits a unique identification code. The unique code could be associated with a physical address of the intended recipient. In this method of programming, a return address, i.e., the address of the logistics management client 230, could be built into the tracking device 100.

A further variation of the above means is an externally readable serial number, which may be printed on the substrate 101 of the tracking device 100. This serial number could be input to a separate automatic or manual process of pairing.

In terms of programming the tracking device 100, in some embodiments, the processor 110 can contain preprogrammed, executable software. In alternate embodiments, the tracking device 100 could configuration mapping information that produces the desired operation instantiating one or more functions that are available within the tracking device 100. In this embodiment, the tracking device 100 could be manufactured with preset capabilities that are available via programming according to the application. By way of example, for the direct mail marketing use case, programming may include correlating a physical address of a mail recipient with a specific tracking device 100. Programming may also include, providing time information to memory 102 or clock 160 and setting an address for the logistics management client 230.

In one embodiment, the programming of the tracking device 100 can operate “in reverse”. In this embodiment, the tracking device 100 could be equipped with a means of transferring its built in electronic identifier to an external device (such as an RFID reader). The external device could be configured to read the tracking device's 100 electronic identifier and associate it with a particular physical mailing address, or other use case metric.

In additional embodiments, the tracking device 100 can be programmed to perform various sensing, monitoring and reporting functions at prescribed intervals and frequencies. Such programming would, for example, set the frequency of temperature reporting if a temperature sensitive item is being tracked. As another example, the temperature threshold for which such monitoring should generate an alarm and report would be programmable.

In one embodiment, the programming is performed using a very simple serial interface in which a bit sequence is applied to the processor 110 through an input-output (I/O) terminal. Tracking devices 100 can be manufactured with the capability of supporting any of a plurality of applications. The multiplicity of capabilities is described by the types of sensors available in the application deployment, while the logic that controls the reporting is described by internal digital logic that is configurable through either manufacturing parameter settings (hard coding) or through the aforementioned serial I/O port. In certain embodiments, the multiplicity of sensor 170 types and configurations, especially the external sensor circuitry, is managed separately from the multiplicity of reporting and monitoring settings. The reporting and monitoring settings may be controlled through digital logic. When the digital processor 110 is programmed, the bit pattern input on the serial port induces, or instantiates, a particular configuration of the control logic inside of the processor 110. This configuration can be stored in memory 102, and the particular configuration selected via a memory address or offset or block of addresses.

In another embodiment, the programming of the digital control can be based on finite state recognizer technology. This type of programming is useful when it is desired to make the tracking device 100 especially small. In particular, the digital processor 110 may be designed without a software processor, thereby reducing cost and complexity of the digital subsystem. Finite state recognizer technology is known in the art of computer engineering, especially in the art of compiler design. In short, this technique operates by accepting a string or stream of tokens (in some embodiments of the present disclosure the tokens are simple binary symbols represented by voltages or currents injected through an I/O pin or terminal or port) and sequentially processing said string or stream in order to “parse” the “string sentence” into meaningful directives. Such a stream processing means can be realized by defining certain bit patterns that are recognized and which cause a state machine to transition into desired control states. In one embodiment, the state can be a pointer to a segment of microcode.

In another embodiment, the state can be a register word that controls selected primitive functions that are predefined at tracking device 100 manufacturing time but which are only instantiated as a result the programming. It will be clear to one of ordinary skill in the art of computer programming, especially microcontroller and similar device programming (firmware programming), that the above method can be designed in a manner that removes the need for a resident software control program and associated general purpose processing elements (CPU 110, memory 102, etc.). The benefit of this type of design is minimization of chip complexity (gate count, logic blocks, number of transistors, etc.) and power consumption.

In another embodiment, which is at the other end of the complexity spectrum but which is somewhat more standard, programming of the tracking device 100 can be achieved by loading a program file into memory 102 or the processor 110. This could be done in some embodiments with an I/O device 141.

There are several ways to produce the circuitry 100 with components as functional modules. In one embodiment, we use a classical printed circuit board (“PCB”) made of an epoxy with copper layer, having a protection layer on the copper, whereby a portion of the protection layer is removed. In this embodiment, we include etching in the free copper area. We also strip off the rest of the protection layer from the remaining copper traces. We further include stencil printing of solder paste to the copper traces. The components are “pick & place” and are secured to the PCB via a heating process in a reflow oven for soldering.

In an alternate embodiment, the circuitry 100 could be produced by using a rigid epoxy-copper PCB a thin and flexible Polyimide film with a copper layer in place of the PCB.

In an alternate embodiment, the circuit 100 could be printed via a printing process for conductive traces (e.g. silver traces) to a film (e.g. Polyethylene terephthalate, Polyethylene naphthalate, and the like) using stencil printing of solder paste. In this embodiment, it would be advisable to use low temperature solder paste because these polymer films cannot stand the high solder temperatures of normal soldering. This embodiment could also place components via “pick & place,” followed by heating up for soldering.

In an additional embodiment, the circuit 100 could be printed via a printing process for conductive traces (e.g. silver traces) to a film (e.g. Polyethylene terephthalate, Polyethylene naphthalate, and the like) and stencil printing or normal printing of a glue or binder, which conductively glues the components to the silver traces. In this embodiment, the circuit 100 could be cured at room temperature or heated up for faster curing.

The printing methods for printing the circuits 100 can vary in alternate embodiments. In one embodiment, one could use a screen printing method or process, which has the advantage of providing relatively thick conductive layers with sufficient resolution. In an alternate embodiment, one could use a gravure printing process, which has the advantage of having a lower thickness than screen printing, while still having good resolution.

In an alternate embodiment, the circuit 100 could be printed with a flexographic printing method, which provides thickness similar to gravure and sufficient resolution.

In alternate embodiments, in order to increase thickness, any of the above printing methods could be combined with printing seed layers having electroplating or electro-less platting thereon.

In these methods, diverse curing methods, such as convection heating, infra-red, ultraviolet, ultrasonic, and photonic, could be used. These curing methods are also useful if sintered nanoparticles are used.

Many different materials can be used to print conductive traces, including without limitation: carbon (including graphene), silver, copper, silver plated copper, organic conductive polymers, tin, and inorganic materials like indium tin oxide.

In one embodiment, a tracking device for use in an LPWAN network, a system for using the tracking device, and a method of using the tracking device is disclosed. A small form factor, low power consumption requirements, and/or long data transmission capabilities may be provided. In an embodiment, a tracking device wherein the majority of the electronics are printed on a single substrate is provided. In one embodiment, only a sensor could be located off-substrate. At least one embodiment disclosed herein provides a low-cost, versatile tracking device that can provide accurate analytics about a movable article to individuals or machines seeking information related to at least one of a panoply of metrics that could be reported about the moveable article.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The present disclosure includes embodiments in which exactly one member of the group is present in, employed in, or otherwise relevant to a given product or process. The present disclosure also includes embodiments in which more than one or the entire group of members is present in, employed in or otherwise relevant to a given product or process. Furthermore, it is to be understood that the present disclosure encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the present disclosure, or aspects of the present disclosure, is/are referred to as comprising particular elements, features, etc., certain embodiments of the present disclosure or aspects of the present disclosure consist, or consist essentially of, such elements, features, etc. For purposes of simplicity those embodiments have not in every case been specifically set forth in so many words herein. It should also be understood that any embodiment or aspect of the present disclosure can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the present disclosure. It is intended that the present disclosure be limited only to the extent required by the appended claims and the applicable rules of law.

The preceding description and illustrations of the disclosed embodiments is provided in order to enable a person skilled in the art to make or use the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein. While various aspects and embodiments have been disclosed, other aspects and embodiments are possible. The various aspects and embodiments disclosed are for purposes of illustration and are not intended to be limiting.

What is claimed is:

1. An apparatus, comprising:
a printed antenna;
a printed battery;
a transmitter powered by the printed battery; and
control circuitry configured to control the transmitter to transmit, using the printed antenna, information detected by a sensor.
